(19) United States
(12) Patent Application Publication
(10) Pub. No.: US 2025/0387682 A1
(43) Pub. Date: Dec. 25, 2025

(54) GOLF VEHICLE WITH DISPLAY SYSTEM

(71) Applicant: Textron Inc., Providence, RI (US)

(72) Inventors: Gregory August Theodosakis, Martinez, GA (US); Russell William King, Evans, GA (US); Matthew Zaremba, Evans, GA (US)

(73) Assignee: Textron Inc., Providence, RI (US)

(21) Appl. No.: 18/750,480

(22) Filed: Jun. 21, 2024

(51) Int. Cl. A63B 55/60; A63B 71/06; G06F 3/04847; G06F 3/0488

(52) U.S. Cl. CPC A63B 55/61; A63B 71/0622; A63B 2071/0691; G06F 3/04847; G06F 3/0488

(57) ABSTRACT

A golf cart includes a driveline, multiple tractive elements, a user interface, a communications bus, and processing circuitry. The tractive elements are configured to be driven by the driveline to transport the golf cart. The processing circuitry is configured to acquire data regarding an operation of the golf cart from the communications bus. The processing circuitry is also configured to operate the user interface based on the data regarding the operation of the golf cart. The processing circuitry is also configured to acquire, via the user interface, an adjusted control setting for the golf cart. The processing circuitry is also configured to control, via communications on the communications bus, a system of the golf cart to adjust an operational characteristic of the golf cart based on the adjusted control setting.

### BACKGROUND

The present application relates to a control system for a vehicle. More specifically, the present application relates to a display system for a vehicle.

### SUMMARY

One embodiment relates to a golf cart. The golf cart includes a driveline, multiple tractive elements, a user interface, a communications bus, and processing circuitry. The tractive elements are configured to be driven by the driveline to transport the golf cart. The processing circuitry is configured to acquire data regarding an operation of the golf cart from the communications bus. The processing circuitry is also configured to operate the user interface based on the data regarding the operation of the golf cart. The processing circuitry is also configured to acquire, via the user interface, an adjusted control setting for the golf cart. The processing circuitry is also configured to control, via communications on the communications bus, a system of the golf cart to adjust an operational characteristic of the golf cart based on the adjusted control setting.

Another embodiment of the present disclosure is a display system for a golf cart. The display system includes a touchscreen display and processing circuitry. The processing circuitry is configured to acquire data regarding an operation of the golf cart from a communications bus of the golf cart. The processing circuitry is also configured to operate the touchscreen display based on the data regarding the operation of the golf cart. The processing circuitry is also configured to acquire, via the touchscreen display, an adjusted control setting for the golf cart. The processing circuitry is also configured to control, via communications on the communications bus, a system of the golf cart to adjust an operational characteristic of the golf cart based on the adjusted control setting.

Yet another embodiment relates to a golf cart. The golf cart includes a dashboard, a touch screen display, and processing circuitry. The touch screen display disposed on the dashboard and is configured to both display information and acquire user inputs. The processing circuitry is configured to acquire fault data from a communications bus of the golf cart. The processing circuitry is also configured to operate the touch screen display to notify a user regarding fault data of the golf cart. The fault data is associated with any of multiple systems communicably coupled with the communications bus. The processing circuitry is also configured to acquire a user input to adjust an operation of a driveline operation of the golf cart. The processing circuitry is also configured to adjust operation of a driveline of the golf cart based on the user input.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a block diagram of a system of the vehicle of FIG. 1, according to an exemplary embodiment.

FIG. 5 is a block diagram of a controller of the vehicle of FIG. 1, according to an exemplary embodiment.

FIG. 6 is a first graphical user interface of a main display screen provided on an operator interface for the vehicle of FIG. 1, according to an exemplary embodiment.

FIG. 7 is a second graphical user interface of another menu provided on the operator interface for the vehicle of FIG. 1, according to an exemplary embodiment.

FIG. 8 is a third graphical user interface of another menu provided on the operator interface for the vehicle of FIG. 1, according to an exemplary embodiment.

FIG. 9 is a fourth graphical user interface of a speed lock provided on the operator interface for the vehicle of FIG. 1, according to an exemplary embodiment.

FIG. 10 is a fifth graphical user interface of a pin prompt for setting the speed on the vehicle of FIG. 1, according to an exemplary embodiment.

FIG. 11 is a sixth graphical user interface of a pin setting for setting a pin of the vehicle of FIG. 1, according to an exemplary embodiment.

FIG. 12 is a seventh graphical user interface of a confirmation screen for confirming the pin set in FIG. 11, according to an exemplary embodiment.

FIG. 13 is an eighth graphical user interface of a menu for selecting between performance information and diagnostics information of the vehicle of FIG. 1, according to an exemplary embodiment.

FIG. 14 is a ninth graphical user interface for setting a maximum speed for the vehicle of FIG. 1, according to an exemplary embodiment.

FIG. 15 is a tenth graphical user interface for navigating to a menu to adjust an acceleration rate of the vehicle of FIG. 1, according to an exemplary embodiment.

FIG. 16 is an eleventh graphical user interface for navigating to a menu to adjust a deceleration rate of the vehicle of FIG. 1, according to an exemplary embodiment.

FIG. 17 is a twelfth graphical user interface for activating or deactivating an economy mode for the vehicle of FIG. 1, according to an exemplary embodiment.

FIG. 18 is a thirteenth graphical user interface for activating regenerative deceleration or a smart skid feature for the vehicle of FIG. 1, according to an exemplary embodiment.

FIG. 19 is a fourteenth graphical user interface for setting an acceleration rate for the vehicle of FIG. 1 responsive to navigation from the graphical user interface of FIG. 15, according to an exemplary embodiment.

FIG. 20 is a fifteenth graphical user interface for setting a deceleration rate for the vehicle of FIG. 1 responsive to navigation from the graphical user interface of FIG. 16, according to an exemplary embodiment.

FIG. 21 is a sixteenth graphical user interface for selecting to view system information of the vehicle of FIG. 1, according to an exemplary embodiment.

FIG. 22 is a seventeenth graphical user interface illustrating system information of the vehicle of FIG. 1 responsive to selection of an icon in the sixteenth graphical user interface of FIG. 21, according to an exemplary embodiment.

FIG. 23 is an eighteenth graphical user interface for selecting to view active events and faults of the vehicle of FIG. 1, according to an exemplary embodiment.

FIG. 24 is a nineteenth graphical user interface for showing active events and faults of the vehicle of FIG. 1 responsive to selection of an icon of the eighteenth graphical user interface of FIG. 23, according to an exemplary embodiment.

FIG. 25 is a twentieth graphical user interface for selecting to view fault history of the vehicle of FIG. 1, according to an exemplary embodiment.

FIG. 26 is a twenty-first graphical user interface for showing fault history of the vehicle of FIG. 1 responsive to selection of an icon of the twentieth graphical user interface of FIG. 25, according to an exemplary embodiment.

FIG. 27 is a twenty-second graphical user interface for selecting to view event history of the vehicle of FIG. 1, according to an exemplary embodiment.

FIG. 28 is a twenty-third graphical user interface for showing event history of the vehicle of FIG. 1 responsive to selection of an icon of the twentieth graphical user interface of FIG. 27, according to an exemplary embodiment.

FIG. 29 is a twenty-fourth graphical user interface for selecting to view battery information of the vehicle of FIG. 1, according to an exemplary embodiment.

FIG. 30 is a twenty-fifth graphical user interface for viewing battery current information of the vehicle of FIG. 1, according to an exemplary embodiment.

FIG. 31 is a twenty-sixth graphical user interface for viewing battery voltage information of the vehicle of FIG. 1, according to an exemplary embodiment.

FIG. 32 is a twenty-seventh graphical user interface for viewing battery health information of the vehicle of FIG. 1, according to an exemplary embodiment.

FIG. 33 is a twenty-eighth graphical user interface for viewing battery temperature information of the vehicle of FIG. 1, according to an exemplary embodiment.

FIG. 34 is a twenty-ninth graphical user interface for selecting to view component monitoring information of the vehicle of FIG. 1, according to an exemplary embodiment.

FIG. 35 is a thirtieth graphical user interface for viewing a list of component monitoring information of the vehicle of FIG. 1, according to an exemplary embodiment.

FIG. 36 is a thirty-first graphical user interface for viewing specific monitoring information of the vehicle of FIG. 1, according to an exemplary embodiment.

FIG. 37 is a thirty-second graphical user interface for changing display units for any of the graphical user interfaces of FIGS. 6-36, according to an exemplary embodiment.

FIG. 38 is thirty-third graphical user interface for selecting which of multiple icons or data to display on the first graphical user interface of FIG. 6, according to an exemplary embodiment.

FIG. 39 is a thirty-fourth graphical user interface for increasing or decreasing the brightness of any of the graphical user interfaces of FIGS. 6-36, according to an exemplary embodiment.

FIG. 40 is a diagram illustrating the fourth graphical user interface displayed on an operator interface of the vehicle of FIG. 1, according to an exemplary embodiment.

FIG. 41 is a diagram illustrating the twelfth graphical user interface displayed on the operator interface of the vehicle of FIG. 1, according to an exemplary embodiment.

FIG. 42 is a diagram illustrating the sixteenth graphical user interface displayed on the operator interface of the vehicle of FIG. 1, according to an exemplary embodiment.

FIG. 43 is a diagram illustrating the twenty-fourth graphical user interface displayed on the operator interface of the vehicle of FIG. 1, according to an exemplary embodiment.

FIG. 44 is a diagram illustrating the twenty-sixth graphical user interface displayed on the operator interface of the vehicle of FIG. 1, according to an exemplary embodiment.

FIG. 45 is a diagram illustrating the twenty-eighth graphical user interface displayed on the operator interface of the vehicle of FIG. 1, according to an exemplary embodiment.

FIG. 46 is a diagram illustrating the twenty-seventh graphical user interface displayed on the operator interface of the vehicle of FIG. 1, according to an exemplary embodiment.

FIG. 47 is a diagram illustrating the second graphical user interface displayed on the operator interface of the vehicle of FIG. 1, according to an exemplary embodiment.

FIG. 48 is a diagram illustrating the eighth graphical user interface displayed on the operator interface of the vehicle of FIG. 1, according to an exemplary embodiment.

FIG. 49 is a diagram illustrating another embodiment of the eighth graphical user interface displayed on the operator interface of the vehicle of FIG. 1, according to an exemplary embodiment.

FIG. 50 is a diagram illustrating the thirty-third graphical user interface displayed on the operator interface of the vehicle of FIG. 1, according to an exemplary embodiment.

FIG. 51 is a diagram illustrating the ninth graphical user interface displayed on the operator interface of FIG. 1, according to an exemplary embodiment.

FIG. 52 is a diagram illustrating different icons that can be displayed in the first graphical user interface, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a golf cart includes a display screen. The display screen is operated by processing circuitry to provide textual and graphical representations of various operational, fault, and diagnostics data obtained via a communications bus of the vehicle. The display screen is also operated to provide different alerts and warnings responsive to conditions such as weather, golf-specific conditions or data, and faults in an electrical system or driveline of the vehicle (e.g., a golf cart). Advantageously, the display screen facilitates improved operator experience and troubleshooting by providing different fault and diagnostic data on the front-end, thereby removing the requirement to connect a diagnostics scanning tool.

### Overall Vehicle

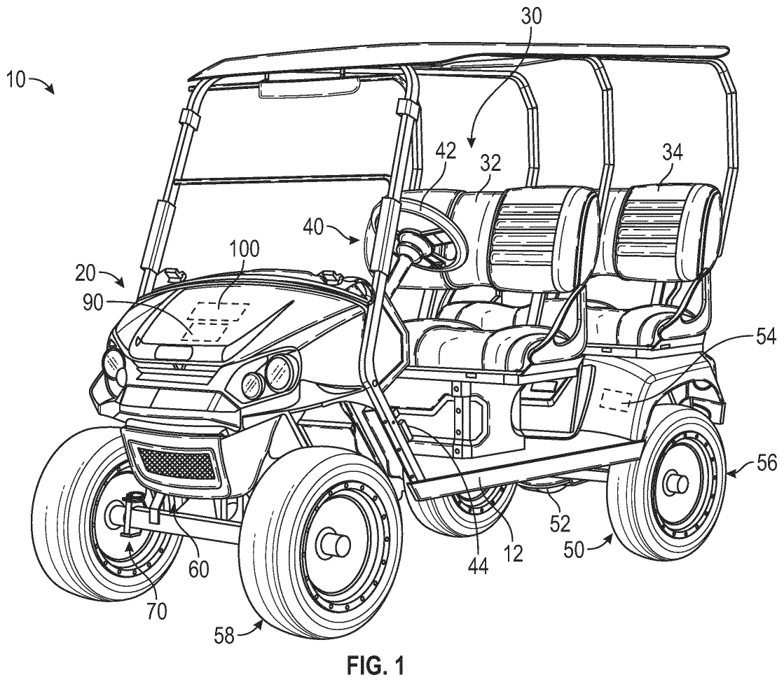

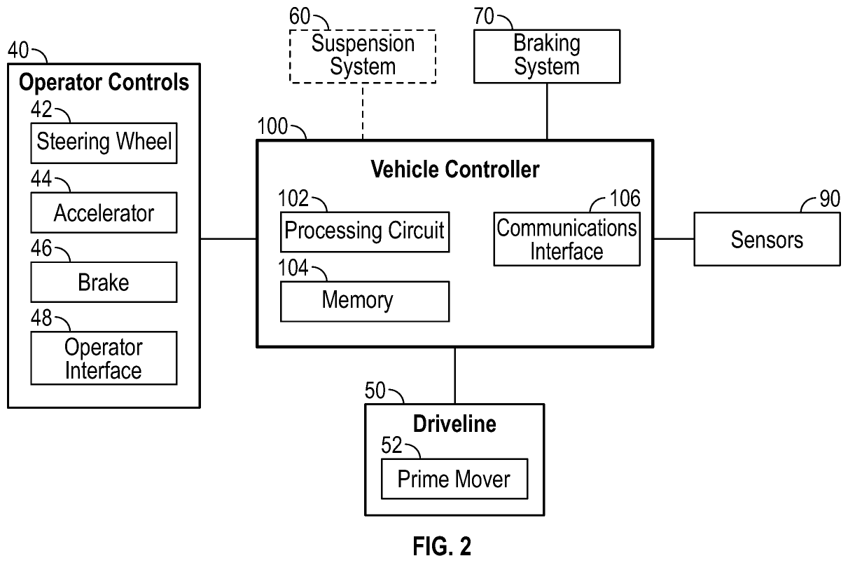

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

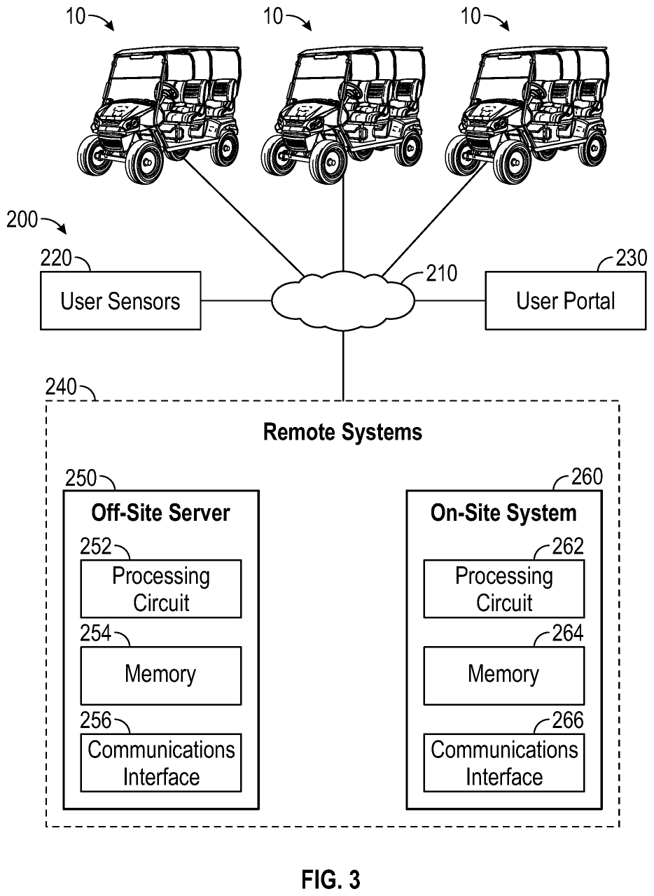

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Display System

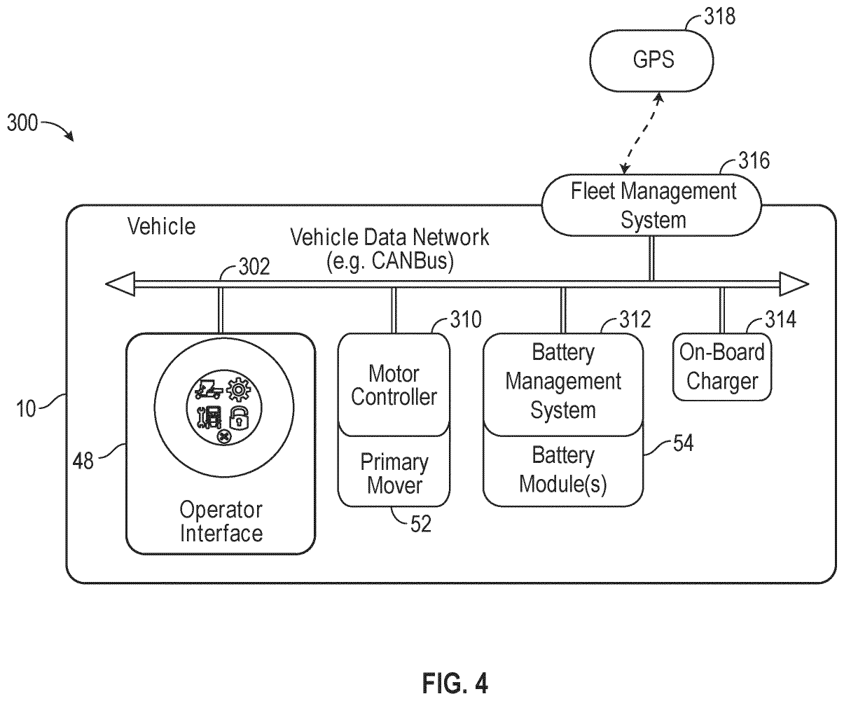

Referring to FIG. 4, the vehicle 10 includes a system 300. The system 300 includes a bus 302 (e.g., a controller area network bus, a communications bus, etc.) configured to communicably couple different devices of the vehicle 10. The system 300 includes the operator interface 48, a motor controller 310, a battery management system (“BMS”) 312, an on-board charger 314, a fleet management system (“FMS”) 316, and a Global Positioning System (“GPS”) 318. The operator interface 48 may be a touch screen interface that is configured to both display data and to obtain user inputs. The operator interface 48 is communicably coupled with the bus 302 and may be positioned proximate the operator controls 40. The motor controller 310 is also communicably coupled with the bus 302 and is configured to operate the primary mover 52. The motor controller 310 may receive commands or controls from the operator interface 48, from the operator controls 40, etc., and operates the primary mover 52 according to the commands or controls. The battery management system 312 is communicably coupled with the bus 302 and is configured to receive communications to control charge or discharge of the battery modules.

The fleet management system 316 is communicably coupled with the bus 302 and communicates with the GPS 318 to determine a position of the vehicle 10. The fleet management system 316 may also be configured to communicate with a cloud computing system or other vehicles 10 in order to obtain various information regarding golf course layout, positions of other vehicles on the golf course, terrain of the golf course, positions or locations or different holes on the golf course, trails and maps of the golf course, etc.

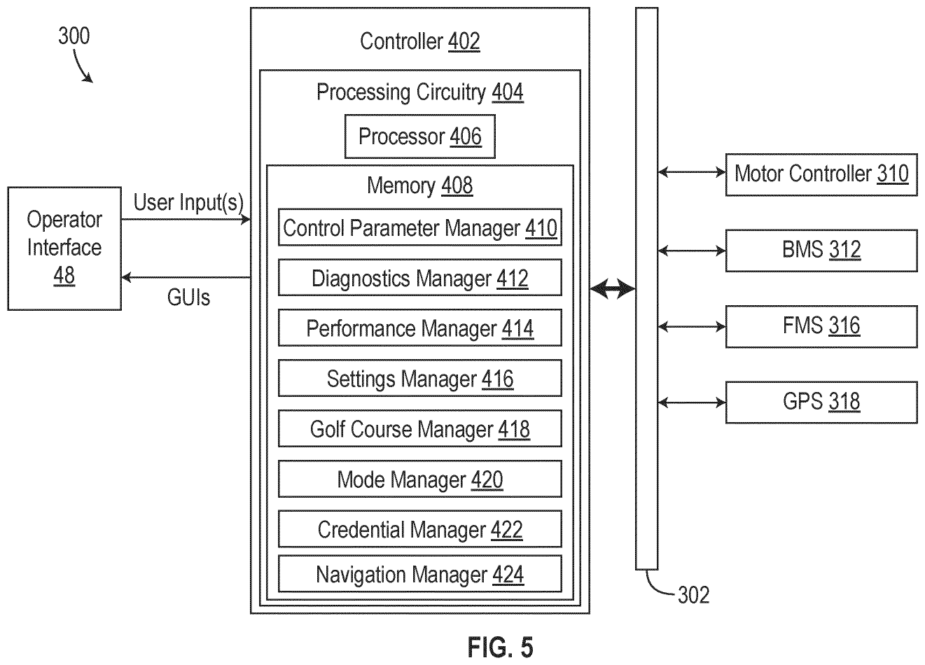

Referring to FIG. 5, the system 300 includes a controller 402 configured to operate the operator interface 48 to display various data. The controller 402 may be a processor or circuit of the operator interface 48 programmed to receive user inputs from the operator interface 48, and adjust one or more operational parameters of the vehicle 10, or present data via the operator interface 48 in one or more graphical user interfaces (“GUIs”). The controller 402 includes processing circuitry 404 including a processor 406 and memory 408. Processing circuitry 404 can be communicably connected to a communications interface such that processing circuitry 404 and the various components thereof can send and receive data via the communications interface. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuitry 404 and includes computer code for executing (e.g., by processing circuitry 404 and/or processor 406) one or more processes described herein.

The controller 402 is communicably coupled with the motor controller 310, the BMS 312, the FMS 316, and the GPS 318 via the bus 302. In some embodiments, the controller 402 is coupled to the vehicle controller 100. In some embodiments, the controller 402 is the vehicle controller 100. In some embodiments, the controller 402 is coupled to the sensors 90. The controller 402 includes a control parameter manager 410, a diagnostics manager 412, a performance manager 414, a settings manager 416, a golf course manager 418, a mode manager 420, a credential manager 422, and a navigation manager 424, according to some embodiments. The control parameter manager 410 is configured to provide different control parameters to the motor controller 310 that change operation (e.g., maximum speed, acceleration, etc.) of the vehicle 10. The control parameter manager 410 is configured to operate the operator interface 48 to provide one or more operating parameter GUIs in order to obtain values of the control parameters from the operator interface 48. The diagnostics manager 412 is configured to obtain diagnostics data from any of the motor controller 310, the BMS 312, the FMS 316, or the sensors 90, and operate the operator interface 48 to provide diagnostics information regarding the vehicle 10 via one or more diagnostics GUIs. The performance manager 414 is configured to obtain one or more performance characteristics of the vehicle 10 or related systems from, or based on data from the motor controller 310, the BMS 312, the FMS 316, the sensors 90, or the GPS 318, and control the operator interface 48 to display the one or more performance characteristics via performance GUIs on the operator interface 48. The settings manager 416 is configured to provide one or more settings GUIs to the user via the operator interface 48 and receive inputs to adjust settings or display parameters of the operator interface 48.

The golf course manager 418 is configured to communicate with the FMS 316 and the GPS 318, and receive information regarding the position of the vehicle 10 and a golf course or terrain for the vehicle 10. The golf course manager 418 is configured to operate the operator interface 48 to display golf-course related information on the operator interface 48 implemented within one or more golf course GUIs, or within other GUIs. The mode manager 420 is configured to provide one or more mode selection GUIs or mode selection icons on the operator interface 48 such that, when different modes are selected, the GUIs or information displayed on the operator interface 48 is adjusted according to the selected or active mode. The credential manager 422 is configured to operate the operator interface 48 to provide one or more credentials GUIs to prompt and allow the user to input a credential via the operator interface 48. The credential manager 422 may adjust which of the GUIs are capable of being provided to the user via the operator interface 48 and may restrict or allow the operations of the control parameter manager 410, the diagnostics manager 412, the performance manager 414, the settings manager 416, the golf course manager 418, or the mode manager 420. The navigation manager 424 is configured to transition the operator interface 48 between different GUIs and facilitates navigation and interaction between the operator interface 48 and the GUIs displayed by the controller 402. The navigation manager 424 can also be configured to display one or more main GUIs from which the user can navigate to other GUIs presented.

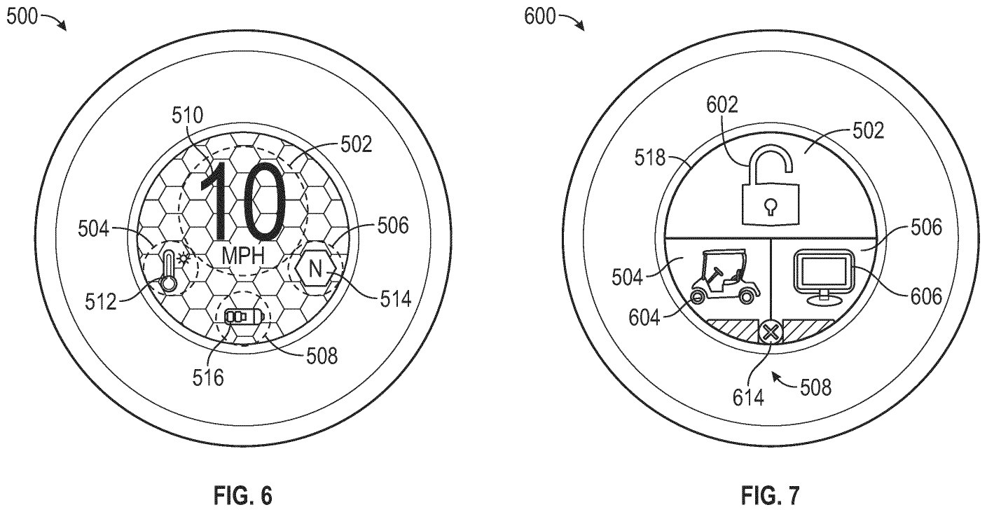

Referring to FIGS. 5-8, the navigation manager 424 is configured to operate the operator interface 48 to display a first GUI 500, a second GUI 600, or a third GUI 700. The first GUI 500 may be a default GUI that is displayed to provide information regarding the vehicle 10. The first GUI 500 may be displayed after a period of inactivity or following a period of lack of interaction by the user or operator with the operator interface 48. The first GUI 500 includes a first area 502 within which first information is displayed, a second area 504 within which second information is displayed, a third area 506 within which third information is displayed, and a fourth area 508 within which fourth information is displayed. The information that is displayed in each of the different areas 502-508 may be adjusted or vary based on a currently selected mode of the operator interface 48, or based on user-defined preference via the operator interface 48. In the implementation of the default GUI 500 shown in FIG. 6, the first information is a speed 510 of the vehicle 10 (e.g., if the speed of the vehicle 10 is greater than zero), the second information is a temperature cutback icon 512 (e.g., indicating that the temperature at the battery modules is currently high), the third information is a drive mode selection indicator 514 (e.g., that the vehicle 10 is currently in neutral), and the fourth information is a battery level icon 516 (e.g., indicating a state of charge of the battery modules). In some embodiments, the user may navigate to third GUI 700 from GUI 600 by selecting the lock icon 602.

The first information may include any of a distance from the vehicle 10 to a golf pin (e.g., in a golf GPS mode) where the distance is displayed as an icon with a number and indicates a number of meters or yards to the golf pin, a distance to a center of a golf course or golf hole (e.g., in the golf GPS mode) where the distance to the center is displayed as an icon indicating a number of yards or meters to the center, the speed of the vehicle 10 as shown, or a state of charge of the battery modules 48 (e.g., a numerical or textual display in 5% intervals), among other possible information. The second information may include any of whether the vehicle 10 is currently being charged, whether the vehicle 10 is currently experiencing a fault, whether hot or cold temperature cutback is currently active (as shown), whether one or more parameters or performance characteristics are locked (e.g., a lock icon if the restriction on speed or other performance characteristic is greater than zero), whether the vehicle 10 is currently on a predetermined path or within an area (e.g., whether the vehicle 10 has left a golf cart path), a golf hole number that the vehicle 10 is currently on, or none), among other possible information. The third information may include any of whether a walkaway feature is active or engaged, whether a tow feature is active or engaged, a slow play icon (e.g., a turtle) in the golf GPS mode, a hole index (e.g., a par in the golf GPS mode), or a drive mode selection as shown), among other possible information. The fourth information may include any of whether the battery modules 48 are currently being charged and a time to complete the charge, a locked icon (if the speed of the vehicle is zero), a seat switch, whether the battery modules 48 are low, a neutral drive warning, whether the vehicle 10 is at or within a restricted area or geofence (e.g., a geofence violation in the golf GPS mode), a conditions alert icon (e.g., derating of the primary mover 52, or a speed zone alert in the golf GPS mode), a weather warning icon (e.g., a storm cloud lightning bolt to indicate an incoming or current storm in the golf GPS mode), an hour meter (if selected), an odometer (if selected), or a state of charge as shown), among other possible information.

Referring still to FIGS. 5 and 6, the navigation manager 424 may operate the operator interface 48 to display the first information, the second information, the third information, and/or the fourth information. The information that is displayed as the first information, the second information, the third information, or the fourth information may be determined based on a prioritization or user preference of the different information that can be displayed in each of the first area 502, the second area 504, the third area 506, or the fourth area 508. Responsive to tapping, swiping, or otherwise interacting with the GUI 500 (e.g., displayed on the operator interface 48), the navigation manager 424 operates the operator interface 48 to display the second GUI 600 (e.g., a main menu) shown in FIG. 7.

Referring to FIGS. 5 and 7, the second GUI 600 displays the main menu that may be presented to the user via the operator interface 48. The second GUI 600 includes the first area 502, the second area 504, the third area 506, and the fourth area 508. The first area 502 includes a lock icon 602, the second area 504 includes a vehicle icon 604 (e.g., a golf cart), and the third area 506 includes a system icon 606 (e.g., a computer). The fourth area 508 includes a selection bar 614 (e.g., a red selection bar) that, when pressed or selected by the user at any GUI described herein, returns to the user to a previously viewed GUI. The selection bar 614 may be provided in all of the GUIs of the operator interface 48 in order to provide a navigable item to return to the default GUI or screen (e.g., the first GUI 500). The second GUI 600 may include highlighted boundaries 518 in order to delineate between the first area 502, the second area 504, the third area 506, and the fourth area 508. In some embodiments, the boundaries 518 are optional. Responsive to selection of the lock icon 602 or the first area 502 at the GUI 600, the navigation manager 424 may operate the operator interface 48 to display one or more lock GUIs (e.g., GUI 700, GUI 800, GUI 900, GUI 1000, GUI 1100). Responsive to selection of the vehicle icon 604 or the second area 504 of the GUI 600, the controller 402 operates the operator interface 48 to provide one or more vehicle GUIs (e.g., GUI 1200). Responsive to selection of the system icon 606 or the third area 506, the controller 402 operates the operator interface 48 to display one or more system GUIs (e.g., GUI 3700, GUI 3800, or GUI 3900). The lock icon 602 may indicate whether a speed limit is set and/or whether the vehicle 10 is locked (i.e., cannot be driven) or unlocked (i.e., can be driven). For example, if the lock icon 602 is gray and unlocked, this indicates that both no credential or pin has been entered, the vehicle 10 is unlocked, and/or that no speed limit is set. Similarly, if the lock icon 602 is green and unlocked, this indicates that a pin has been set, the vehicle 10 is unlocked, and/or no speed limit has been set for the vehicle 10. If the lock icon 602 is red and locked and includes a numerical value (e.g., 0 or 10), this indicates that a speed limit has been set (e.g., 0 mph, 5 mph, 10 mph, 15 mph, 18 mph, etc.) and that the vehicle 10 is currently locked, and when unlocked (e.g., after entering a credential), the vehicle 10 will operate in a restricted manner (e.g., a speed limited manner).

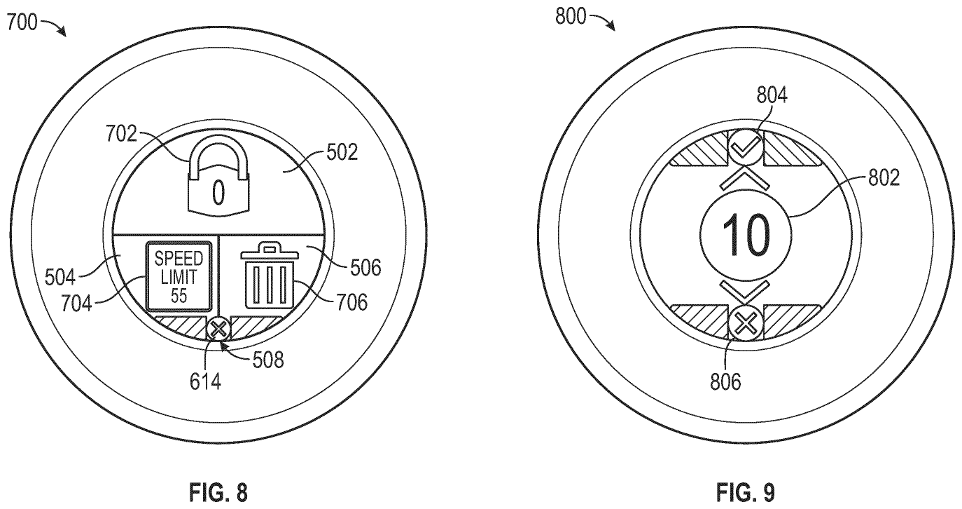

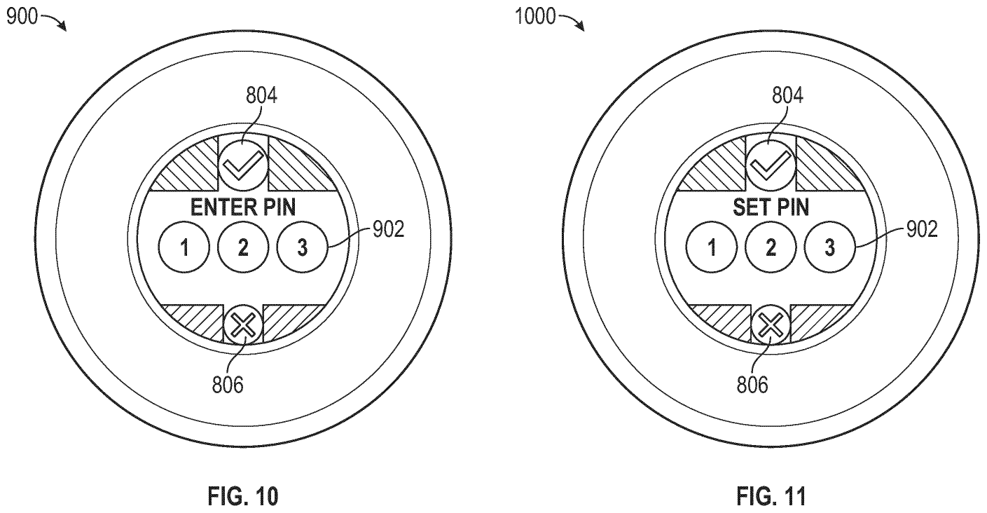

Referring to FIG. 8, the third GUI 700 (e.g., a lock GUI) may be displayed once the operator selects the lock icon 602 in GUI 600. The third GUI 700 includes a lock icon 702 in the first area 502, a speed limit icon 704 in the second area 504, a deletion icon 706 in the third area 506, and the selection bar 614 (e.g., a return bar) in the fourth area 508. Before being presented with the third GUI 700, the user may be presented with a GUI 900, as shown in FIG. 10, in which the user is prompted to enter a pin or credential via selectors 902. The GUI 900 may also include a confirmation icon 804 (e.g., an enter bar, a green check mark) such that once the pin or credential is entered, the pin or credentials are provided to the credential manager 422 to check if the pin or credentials can be verified. If the pin or credential can be verified, then the controller 402 operates the operator interface 48 to provide the GUI 700 to the user. The GUI 700 also includes a cancel icon 806 (e.g., the selection bar 614) to cancel the pin or credential that is currently entered.

The lock icon 702 indicates whether any locks or limits (e.g., speed limit) have been applied to the vehicle 10, similar to the lock icon 602. Responsive to selection of the lock icon 702, the control parameter manager 410 may lock or unlock the vehicle 10 (depending on whether the vehicle 10 is currently locked or unlocked). The controller 402 may first present the user with the GUI 900 to prompt the user to enter a valid pin or credential with sufficient authorization, and responsive to verifying the valid pin or credential, lock or unlock the vehicle 10 as requested by the user upon selecting the lock icon 702 or the first area 502 of GUI 700.

Responsive to selection of the speed limit icon 704, the controller 402 (e.g., the navigation manager 424 or the control parameter manager 410) operates the operator interface 48 to display the GUI 800 (e.g., a speed setting GUI) as shown in FIG. 9. In order to set a speed limit for the vehicle 10 and enter a corresponding pin or credential to operate the vehicle 10 in the speed limited manner, the user may tap a speed icon 802, scroll through multiple values to select a value, and select or touch a confirmation icon 804 to set the speed limit for the vehicle 10. The user may then be prompted with entering a pin or credential at GUI 900 (shown in FIG. 10). Responsive to the pin or credential being entered and the confirmation icon 804 being selected, the credential manager 422 is configured to verify the pin or credential and, if validated, the control parameter manager 410 is configured to set the speed limit for the vehicle 10 according to the limit set at GUI 800 so that the vehicle 10 is prevented from exceeding the speed limit. The speed limit may be presented within the lock icon 702 or the lock icon 602.

Responsive to selection of the deletion icon 706, the pin or credential and any associated speed restriction may be deleted so that the vehicle 10 is not in a speed limited mode. The user may be presented the GUI 900 to enter the pin or credential prior deactivating the speed limited mode. Advantageously, the GUI 700 allows the user to set different speed limits or vehicle locks.

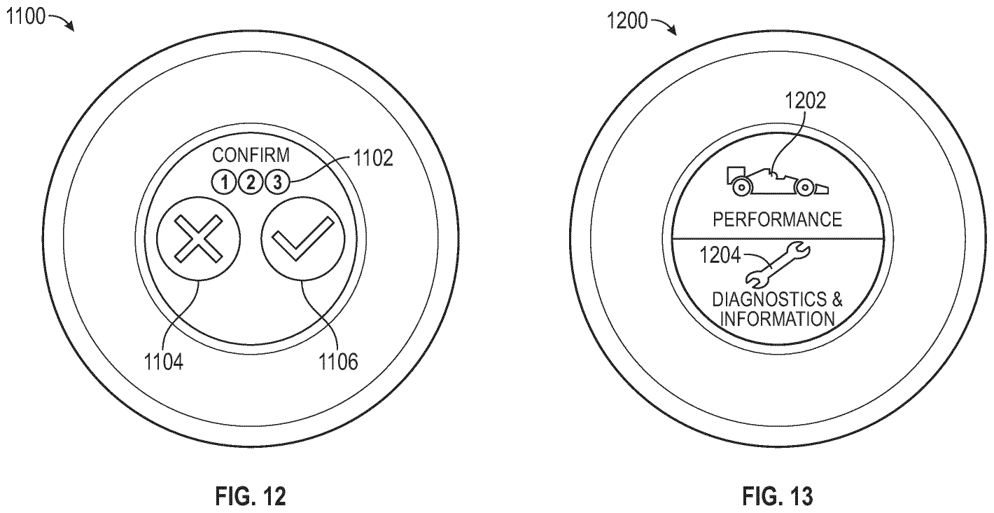

Referring to FIGS. 11 and 12, the user may also be able to set a pin or credential for one or more operations of the vehicle 10 (e.g., speed limiting mode, locked mode, etc.) using the GUI 1000 and the GUI 1100. The pins or credentials for the one or more operations may differ between the different operations. Specifically, a user may set a pin or credential for a specific operation using the GUI 1000 (shown in FIG. 11) and then presented a confirmation message via the GUI 1100 (shown in FIG. 12) where the user is presented with a confirmation message showing the pin or credential to be set, shown as icon 1102, and both a cancel icon 1104 and a confirmation icon 1106.

Referring to FIG. 13, the GUI 1200 includes a performance icon 1202 and a diagnostics icon 1204. The GUI 1200 may be presented to the user responsive to selection of the vehicle icon 604 at GUI 600. The GUI 1200 represents a menu so that the user can either select between setting performance characteristics of the vehicle 10, or view diagnostics and other information of the vehicle 10. Upon selection of the performance icon 1202 on the GUI 1200, the user may be presented with multiple performance GUIs (e.g., GUIs 1300-1900 or GUI 800). Upon selection of the diagnostics icon 1204, the user may be presented with multiple diagnostics GUIs (e.g., GUIs 2100-3600). The user may be able to select, set, or lock one or more performance characteristics of the vehicle 10 via the performance GUIs. In some embodiments, in order for the user to set or adjust various performance characteristics of the vehicle 10, the user must enter a valid pin or credential as described in greater detail above with reference to FIGS. 10-12.

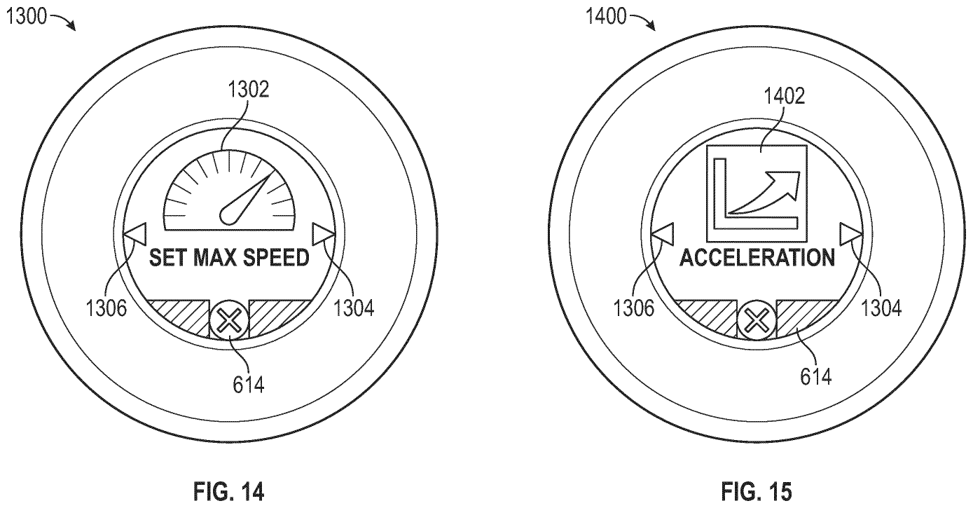

Referring to FIG. 14, a first performance GUI, shown as speed GUI 1300, includes a dial 1302, the selection bar 614 (e.g., to return to a previous GUI or a main menu), a first selector 1304 (e.g., a right arrow), and a second selector 1306 (e.g., a left arrow). Upon selection of the first selector 1304, the controller 402 operates the operator interface 48 to display a next performance GUI. Similarly, upon selection of the second selector 1306, the controller 402 operates the operator interface 48 to display a previous performance GUI. It should be understood that all of the performance GUIs described herein include the first selector 1304 and the second selector 1306 in order to allow the user to navigate between different performance GUIs. In some embodiments, any GUIs described in the present application that include the first selector 1304 and the second selector 1306 may allow a user to navigate between GUIs by swiping left or right on the screen instead of or in addition to tapping the first selector 1304 and the second selector 1306. The speed GUI 1300 may also be provided as the GUI 800. The speed GUI 1300 allows the user to select the dial 1302 and set a speed (e.g., a maximum allowable speed for the vehicle 10). Upon selection of the dial 1302, the user may be presented with the speed icon 802 such that the user can scroll through different speed values and release once a selected speed limit is found. Once the speed limit is set at the speed GUI 1300, the controller 402 (e.g., the control parameter manager 410 or the performance manager 414) uses the speed limit in order to control operation of the vehicle 10 (e.g., the motor controller 310) to limit the vehicle 10 from exceeding the speed limit.

Referring to FIG. 15, a second performance GUI, shown as acceleration GUI 1400, includes an acceleration icon 1402, the first selector 1304, the second selector 1306, and the selection bar 614. The acceleration icon 1402 may be selectable, similar to the dial 1302, in order to set an acceleration limit for the vehicle 10. The user may select the acceleration icon 1402, scroll through different values of acceleration limit, or otherwise adjust the acceleration limit, in order to select the acceleration limit. Once the user has selected the acceleration limit, the controller 402 (e.g., the control parameter manager 410 or the performance manager 414) uses the acceleration limit to control operation of the vehicle 10 (e.g., the motor controller 310) to the limited acceleration as set at the acceleration GUI 1400.

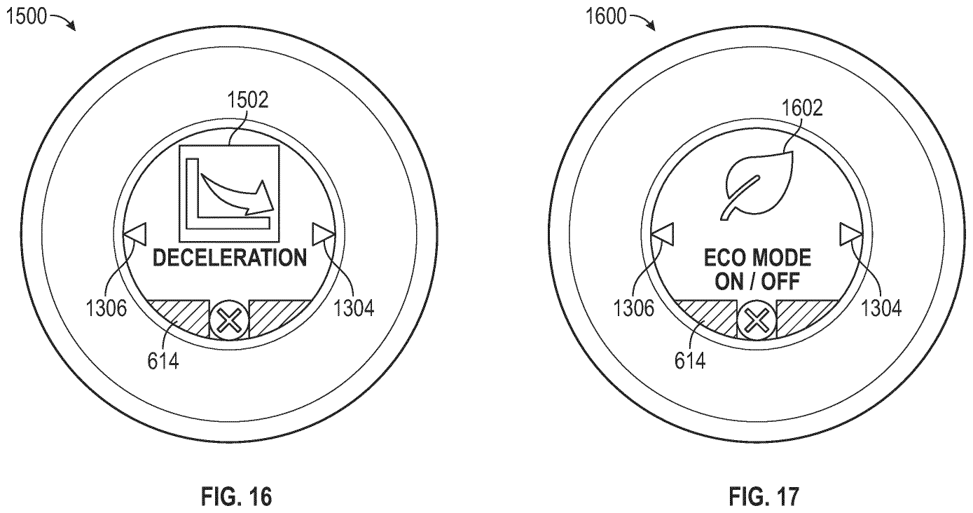

Referring to FIG. 16, a third performance GUI, shown as deceleration GUI 1500, includes a deceleration icon 1502, the first selector 1304, the second selector 1306, and the selection bar 614. The deceleration GUI 1500 may be similar to the acceleration GUI 1400 but in order to set a deceleration limit or minimum threshold for the vehicle 10. For example, the user may set, via the deceleration GUI 1500, a threshold minimum or maximum deceleration limit for the vehicle 10 such that, when the user releases the accelerator 44, the vehicle 10 decelerates at the threshold set at the deceleration GUI 1500 (e.g., via regenerative braking).

Referring to FIG. 17, a fourth performance GUI, shown as eco-mode GUI 1600, includes an eco-mode icon 1602, the first selector 1304, the second selector 1306, and the selection bar 614. The eco-mode GUI 1600 allows the user to selectively turn on or off an eco-mode for the vehicle 10. The user may toggle between turning the eco-mode on or turning the eco-mode off by selecting the eco-mode icon 1602. When the eco-mode (e.g., an economy mode or power savings mode) is turned on, the vehicle 10 may be operated according to one or more factory set control parameters (e.g., speed limit, acceleration limit, etc.) in order to reduce power consumption of the vehicle 10 and prolong the lifetime of the energy storage 54. When the eco-mode is turned off, the vehicle 10 may be operated according to the values set by the user via the performance GUIs. When the eco-mode is turned on, the eco-mode icon 1602 may be illuminated or colored to indicate that the eco-mode is turned on and currently active. Likewise, when the eco-mode is turned off, the eco-mode icon 1602 may be shaded gray or discolored so to indicate that the eco-mode is turned off and currently inactive.

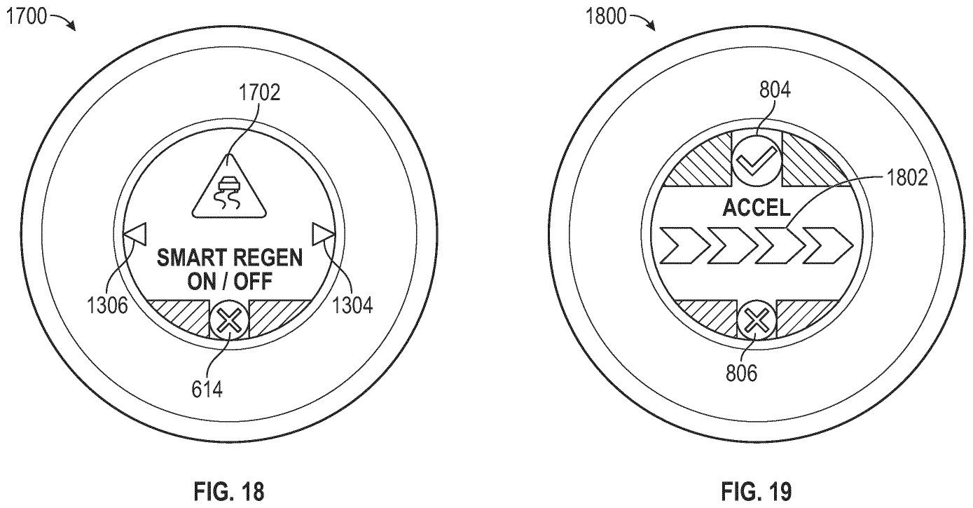

Referring to FIG. 18, a fifth performance GUI, shown as smart regenerative GUI 1700, includes a regenerative icon 1702, the first selector 1304, the second selector 1306, and the selection bar 614. The smart regenerative GUI 1700 may be similar to the eco-mode GUI 1600 and provides the regenerative icon 1702 such that the user may toggle between turning on and turning off regenerative anti-skid features for the vehicle 10. For example, the user may select the regenerative icon 1702 in order to turn on regenerative anti-skid or smart regenerative deceleration for the vehicle 10, and, responsive to selection of the regenerative icon 1702, control the motor controller 310 and the primary mover 52 such that regenerative deceleration is performed by the primary mover 52 (e.g., back-driving the primary mover 52 in order to charge the battery modules when the user lets off the accelerator 44 and presses the brake 46). Likewise, when the regenerative icon 1702 is selected such that regenerative deceleration is turned off, the controller 402 does not operate the motor controller 310 and the primary mover 52 to perform regenerative deceleration when the brake 46 is depressed by the user. The regenerative icon 1702 may be highlighted, lit up, or provided with color when the regenerative deceleration is activated in order to notify the user whether regenerative deceleration is currently active or inactive.

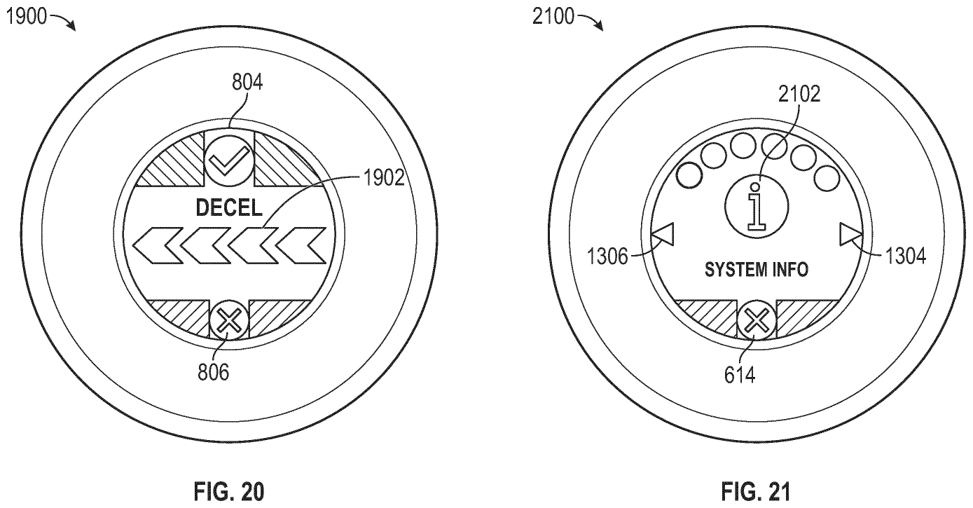

Referring to FIGS. 19 and 20, sixth and seventh performance GUIs, shown as acceleration GUI 1800 and deceleration GUI 1900, include a confirmation icon 804, a cancel icon 806, and an acceleration selection bar 1802 and a deceleration selection bar 1902, respectively. The acceleration GUI 1800 may be provided in place of or in addition to the acceleration GUI 1400 (e.g., when the user selects the acceleration icon 1402 or the deceleration icon 1502). The user may select the acceleration selection bar 1802 or the deceleration selection bar 1902 in order to add discrete sections or widgets indicating a selected value of allowable acceleration or deceleration. In some embodiments, the acceleration selection bar 1802 and the deceleration selection bar 1902 provide a visual representation of the amount of acceleration or deceleration selected by the user (as opposed to specific numerical values). The user may select the confirmation icon 804 in order to confirm the selected acceleration limit as indicated via the acceleration selection bar 1802 or the selected deceleration limit as indicated via the deceleration confirmation bar 1902 is desired.

Referring again to FIGS. 14-20, an eighth performance GUI may be provided for cruise control operation of the vehicle 10 including a cruise control icon. Additionally or alternatively, the GUI 500 or any other GUI that is displayed while the vehicle 10 is operated may include the cruise control icon for controlling operation of cruise control of the vehicle 10. Responsive to selection of the cruise control icon, the controller 410 or the operator interface 48 may operate the motor controller 310 to maintain the vehicle 10 at a current speed at the time at which the cruise control icon is selected. The vehicle 10 is maintained at the current speed without requiring operation of the accelerator 44. The vehicle 10 may maintained at the current speed until at least one of (i) the cruise control icon is again selected, (ii) the brake 46 is operated, or (iii) a key of the vehicle 10 is transitioned into an off-position (e.g., the vehicle 10 is shut off).

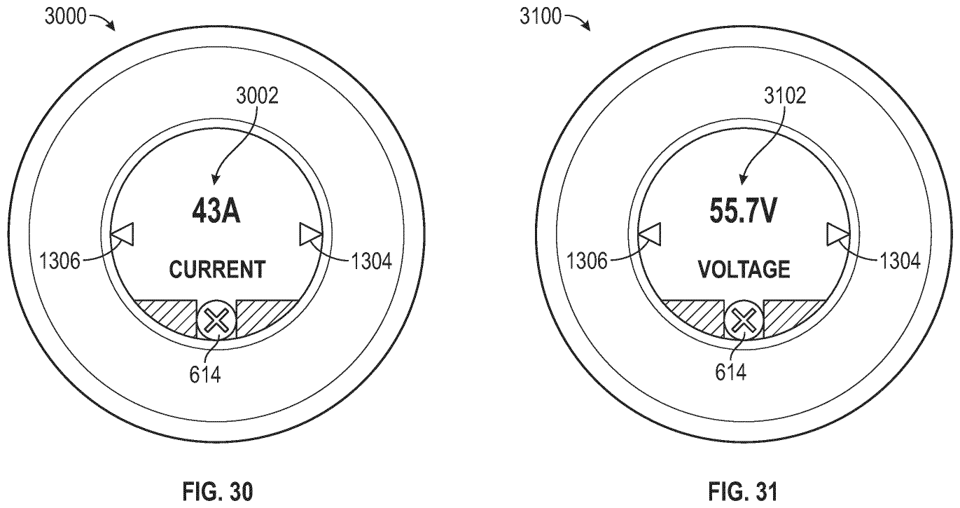

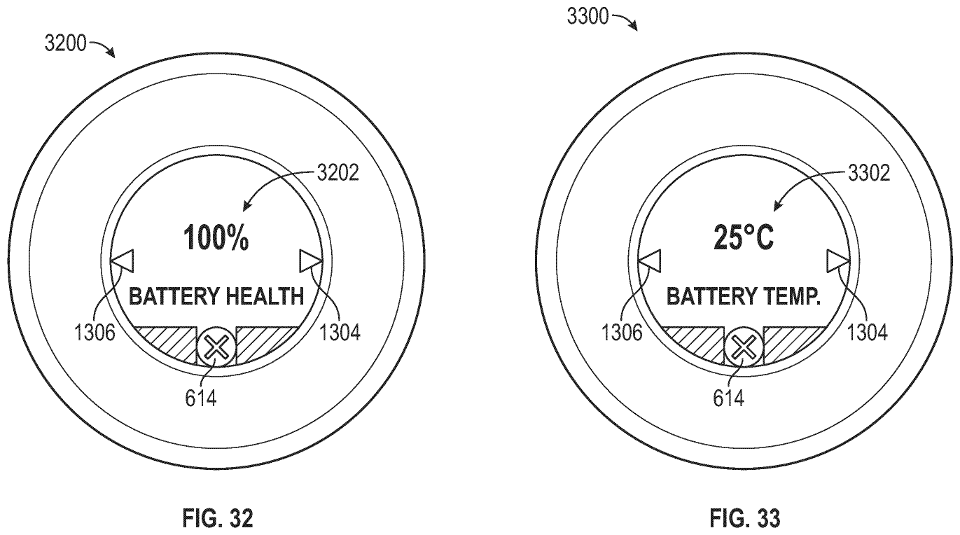

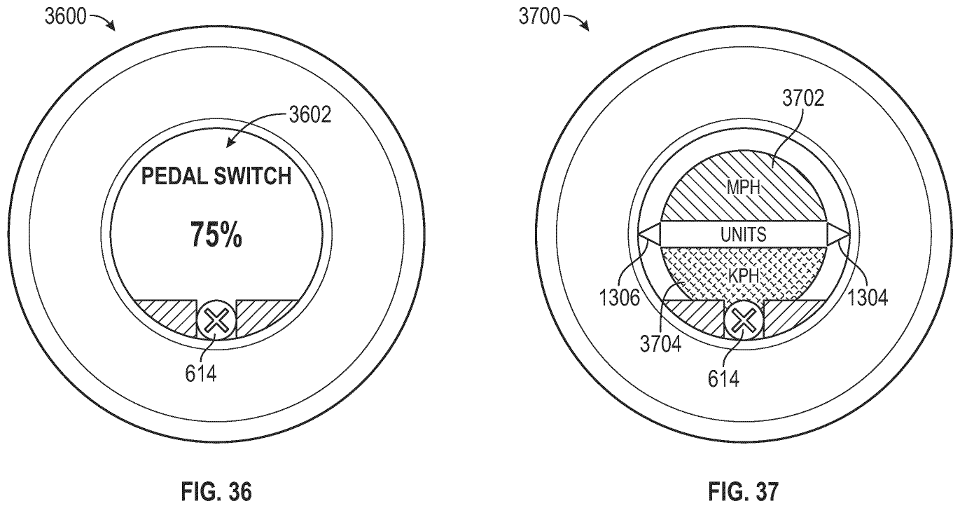

Referring to FIGS. 21-36, various diagnostics GUIs are shown, according to various embodiments. The diagnostics GUIs shown and described herein with reference to FIGS. 21-36 may be presented to the user responsive to selection of the diagnostics icon 1204 of the GUI 1200. The diagnostics GUIs allow the user to view and inspect various diagnostics data, alerts, alarms, or warnings via the operator interface 48, without requiring the user or a technician to connect a diagnostics tool in order to view diagnostics data. The diagnostics GUIs may also include a light or progression indicator including discrete icons indicating a number of diagnostics GUIs that can be toggled through. One of the discrete icons are lit up or otherwise indicated to indicate which of the diagnostics GUIs the user is currently viewing.

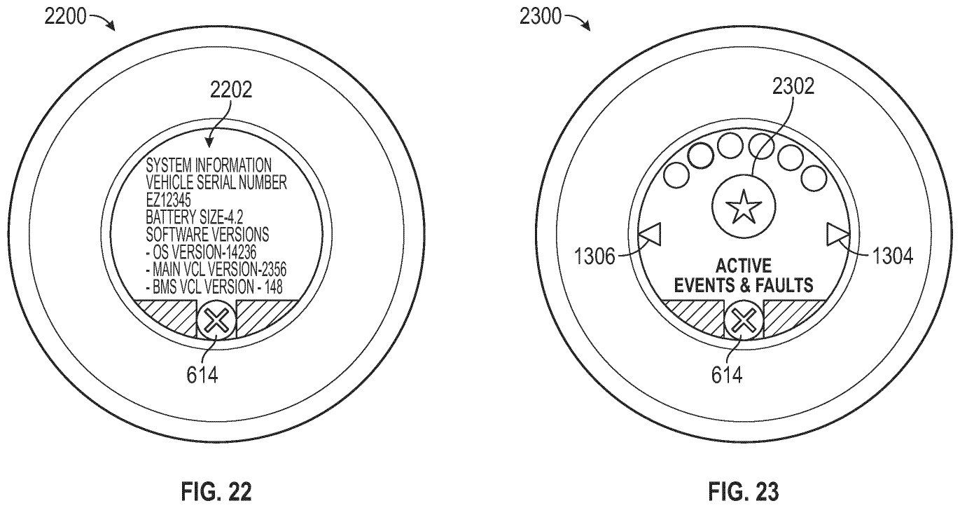

Referring particularly to FIGS. 21 and 22, first diagnostics GUIs are provided as system information GUIs 2100 and 2200. The system information GUI 2100 may be similar to the performance GUIs described in greater detail above and includes the first selector 1304, the second selector 1306, and the selection bar 614. The user may select the first selector 1304 and the second selector 1306 in order to transition between different diagnostics interfaces. In order to return to the main menu (e.g., the GUI 500 or the GUI 600) or a previous GUI, the user may select the selection bar 614.

The system information GUI 2100 also includes a system information icon 2102. Upon selection of the system information icon 2102, the controller 402 is configured to operate the operator interface 48 to present the system information GUI 2200. The system information GUI 2200 includes textual data 2202 that the user may select and scroll through to read. The textual data 2202 includes various information regarding the serial number of the vehicle 10, a size of the battery modules, software versions, etc., and other system information of the vehicle 10. When the user has completed reading the textual data 2202 or wishes to go back, the user may select the selection bar 614 in order to return to the system information GUI 2100.

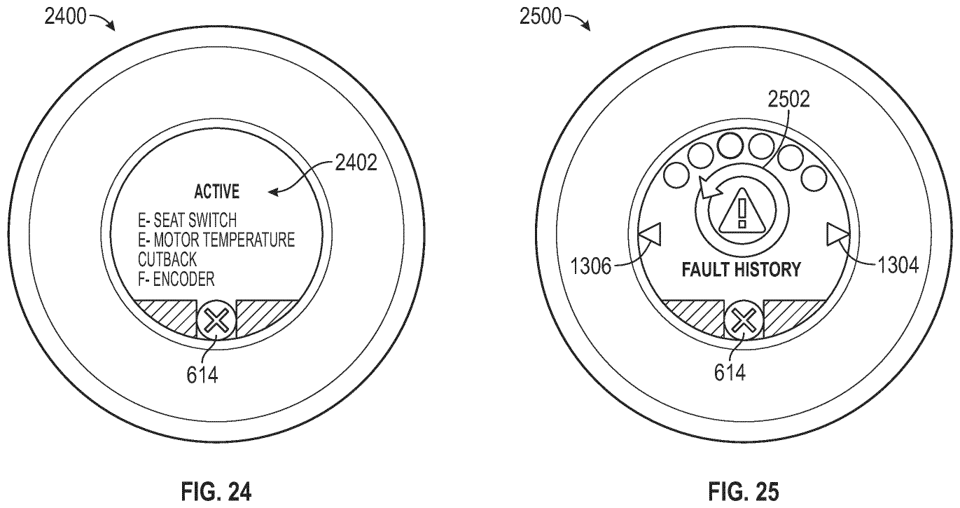

Referring to FIGS. 23 and 24, second diagnostics GUIs, shown as active faults GUI 2300 and active faults GUI 2400 are provided. The active faults GUI 2300 includes the first selector 1304, the second selector 1306, and the selection bar 614. The active faults GUI 2300 also include a fault icon 2302 that may be highlighted or otherwise indicated if any faults of the vehicle 10 have been detected by the controller 402 and are active. Upon selection of the fault icon 2302, the controller 402 operates the operator interface 48 to provide the active faults GUI 2400. The active faults GUI 2400 includes textual data 2402 indicating which faults or events are currently active and have not been cleared. As shown in the textual data 2402, the active faults, alarms, alerts, or events can include whether a fault with a seat switch has occurred, whether motor temperature has exceeded a threshold or desired value, whether a cutback event has occurred, whether an encoder has undergone a fault, etc.

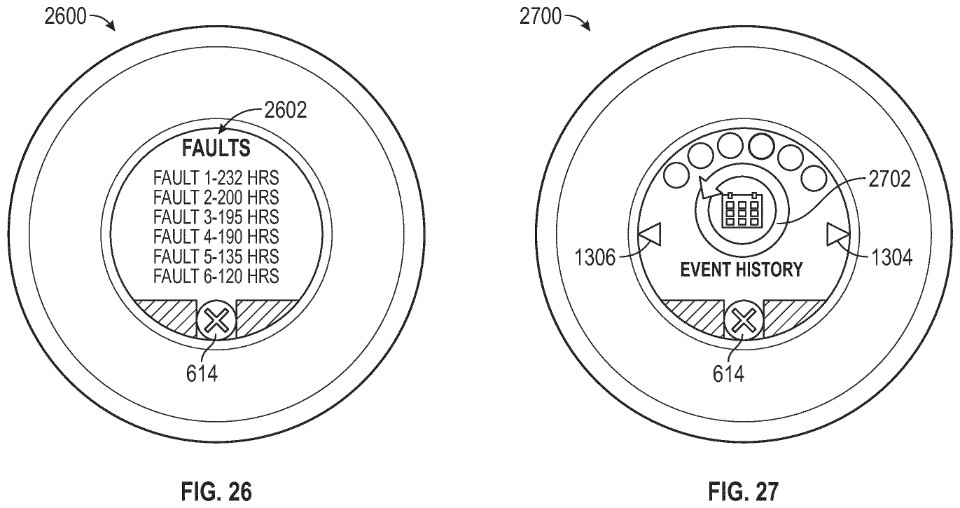

Referring to FIGS. 25 and 26, third diagnostics GUIs, shown as fault history GUIs 2500 and 2600, are provided. The fault history GUI 2500 includes the first selector 1304 and the second selector 1306 in order to scroll between different diagnostic GUIs. The fault history GUI 2500 also includes a fault history icon 2502. Responsive to selection of the fault history icon 2502, the controller 402 operates the operator interface 48 to present the fault history GUI 2600. The fault history GUI 2600 includes textual data 2602 indicating historical faults that the vehicle 10 has experience over a past timer period (e.g., since a last reset, since production, since previous fault history clearing, since the beginning of the day or week, etc.). The user may select the selection bar 614 to return to the fault history GUI 2500. The textual data 2602 may include an indication of a fault that occurred previously, and at what hours of runtime the fault occurred at.

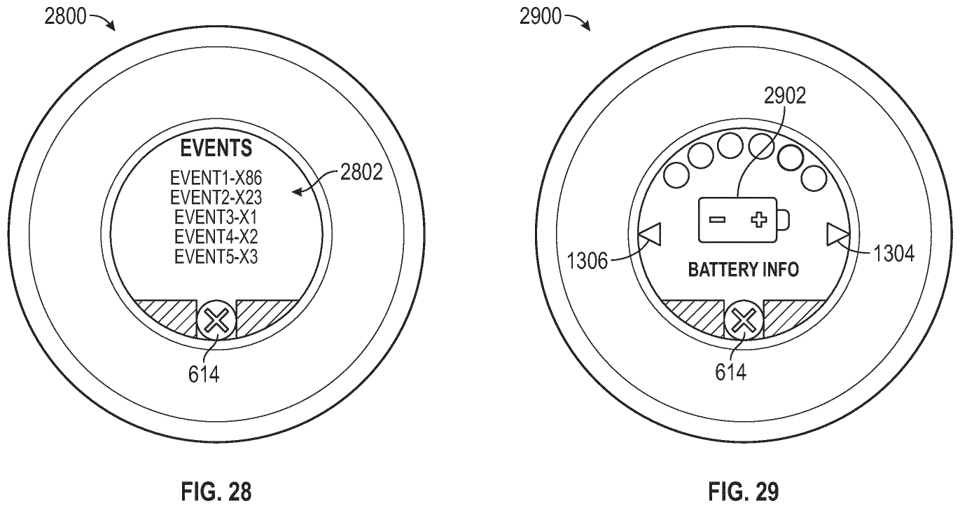

Referring to FIGS. 27 and 28, fourth diagnostics GUIs, shown as event history GUIs 2700 and 2800, are provided. The event history GUI 2700 includes the first selector 1304, the second selector 1306, the selection bar 614, and an event history icon 2702. Upon selection by the user of the event history icon 2702, the controller 402 operates the operator interface 48 to display the event history GUI 2800. The event history GUI 2800 includes event history textual data 2802 similar to the textual data 2602. The event history textual data 2802 may include a listing of previous events of the vehicle 10 and a time (e.g., in terms of runtime) at which the previous events occurred. In some embodiments, one or more of the fault history GUIs 2500 and 2600, and the event history GUIs 2700 and 2800 are provided on a single GUI. For example, the single GUI may include a list of faults and events that may be selected to show the user a timestamp and a count. The single GUI may also include a clear selection that, when selected, clears one or more of the faults or events from the list.

Referring to FIGS. 29-33, fifth diagnostic GUIs, shown as battery information GUIs 3000, 3100, 3200, and 3300, are provided. The fifth diagnostic GUIs may be provided responsive to selection of a battery information icon 2902 on a battery information GUI 2900. Responsive to selection of the battery information icon 2902 (e.g., a battery icon), the controller 402 operates the operator interface 48 to provide the current GUI 3000. The current GUI 3000 displays a discharge or charging current, shown as current display 3002, of the BMS 312 as obtained from sensors of the BMS 312 through the motor controller 310 or directly from the BMS 312. It should be understood that the operator interface 48 may solely with the motor controller 310 and obtain required data for display from the motor controller 310 or may communicate directly with the BMS 312. The discharge or charging current of the BMS 312 provides real-time feedback of the current of energy charging or discharging from the BMS 312 to the operator interface 48 through the motor controller 310 or directly from the BMS 312. Responsive to selection of the first selector 1304 on the GUI 3000, the controller 402 presents a voltage GUI 3100 that displays voltage data 3102 of the BMS 312 as obtained from the motor controller 310 or the BMS 312. The voltage data 3102 may be obtained by the controller 402 from the BMS 312 through the motor controller 310 (or directly from the BMS 312) and presented on the operator interface 48 via the voltage GUI 3100. The user may return to the current GUI 3000 from the voltage GUI 3100 by selecting the second selector 1306.

Responsive to selection of the first selector 1304 on the voltage GUI 3100, the controller 402 presents a battery health GUI 3200 that displays battery health 3202 of the BMS 312. The controller 402 obtains battery health data from the motor controller 310 which receives battery health data from the BMS 312 (e.g., in real-time) or from a sensor of the BMS 312. In some embodiments, the controller 402 obtained battery health data from the BMS 312 directly. The controller 402 displays the battery health 3202 via the operator interface 48 on the battery health GUI 3200. The user may return to the voltage GUI 3100 from the battery health GUI 3200 by selecting the second selector 1306.

Responsive to selection of the first selector 1304 on the battery health GUI 3200, the controller 402 presents a battery temperature GUI 3300 that displays battery temperature 3302 of the BMS 312. The controller 402 obtains battery temperature from a temperature sensor of the BMS 312 (e.g., in real-time) and displays the battery temperature 3302 via the operator interface 48 on the battery temperature GUI 3300. The user may return to the battery health GUI 3200 from the battery temperature GUI 3300 by selecting the second selector 1306. The user may return to the GUI 2900 from any of the GUIs 3000, 3100, 3200, or 3300 by selecting the selection bar 614.

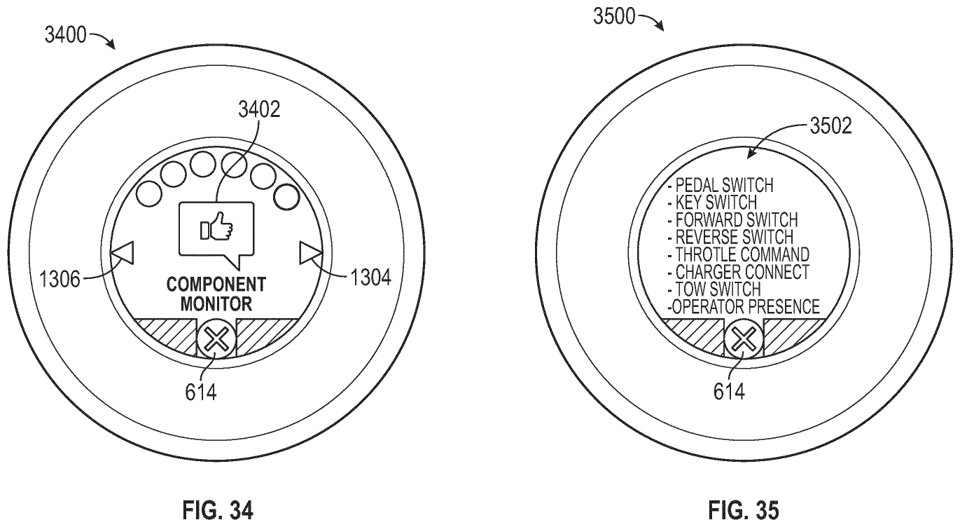

Referring to FIGS. 29 and 34, the user may transition from the battery information GUI 2900 to a component monitor GUI 3400 (e.g., a sixth diagnostic GUI) by selecting the first selector 1304 on the battery information GUI 2900. The component monitor GUI 3400 includes a component monitoring icon 3402 that, upon selection, displays at least one of a first component information GUI 3500 or a second component information GUI 3600. The first component information GUI 3500 includes a list 3502 of different components of the vehicle 10 that can be viewed or selected for further information. The list 3502 may include a pedal switch, a key switch, a forward switch, a reverse switch, a throttle command, a charger connect, a tow switch, etc. The user may scroll through the list 3502 and select one of the components. Responsive to selection of one of the components, the controller 402 obtains information regarding a status of the component, and provides the second component information GUI 3600 to the user via the operator interface 48. The second component information GUI 3600 includes component information 3602 (e.g., in this case, a position of the pedal switch) that is provided to the user in real-time. In this way, the user may scroll via GUI 3500 and select a desired component to view more detailed information regarding that component (e.g., a current signal or position of a switch) via GUI 3600.

Referring to FIGS. 37-39, various system GUIs 3700, 3800, and 3900 may be provided to the user via the operator interface 48 responsive to selection of the system icon 606 at GUI 600. The system GUIs 3700, 3800, and 3900 may include selectable display settings or unit settings for the various GUIs of the vehicle 10 as described herein with reference to FIGS. 6-36 and 40-51. The user may navigate between the GUI 3700, the GUI 3800, and the GUI 3900 by pressing the first selector 1304 or the second selector 1306. The first system GUI 3700 includes a units display where the user may select imperial (e.g., miles per hour) or metric (e.g., kilometers per hour) units. In particular, the first system GUI 3700 includes an imperial icon 3702 and a metric icon 3704 that, when selected, reconfigure any information presented in the GUIs described herein with reference to FIGS. 6-36 and 40-51 to provide information in either imperial or metric units.

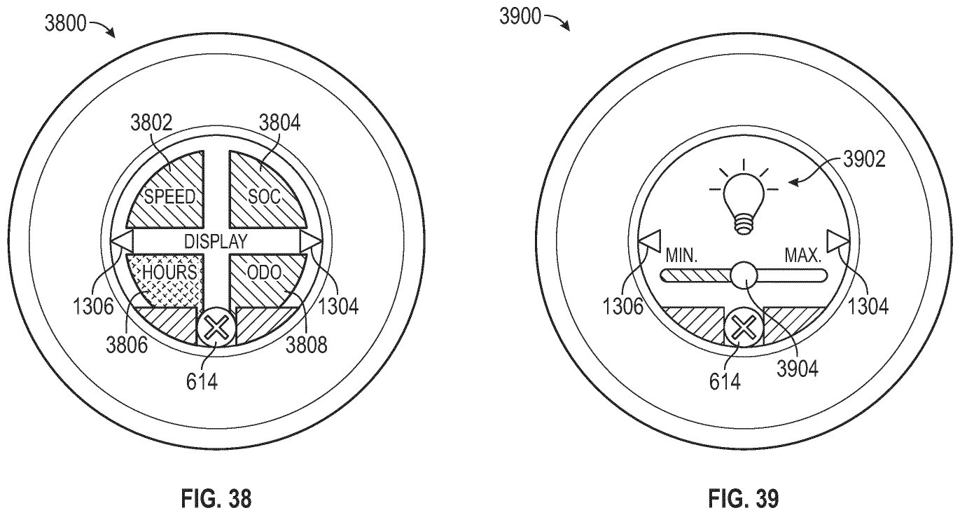

Referring particularly to FIG. 38, the second system GUI 3800 controls what information is displayed on the operator interface 48 in the first GUI 500 (e.g., in the first area 502, the second area 504, the third area 506, and the fourth area 508). For example, the second system GUI 3800 may include a speed icon 3802, a state of charge icon 3804, an hours icon 3806, and an odometer icon 3808. The user may toggle between activation or de-activation of any of the speed icon 3802, the state of charge icon 3804, the hours icon 3806, or the odometer icon 3808. When the icons are activated, the icons are highlighted, and the corresponding information is presented to the user on the first GUI 500. For example, when the speed icon 3802 is selected, the speed icon 3802 may be shaded or highlighted (e.g., with a green color) and the speed of the vehicle 10 is presented on the first GUI 500. Likewise, when the state of charge icon 3804, the hours icon 3806, or the odometer icon 3808 are selected, the icons are highlighted or shaded, and the state of charge of the BMS 312, the total hours runtime of the vehicle 10, or odometer information are presented on the first GUI 500, respectively. Selection of the speed icon 3802 causes the GUI 500 to display the speedometer and automatically deactivates the odometer. Likewise, selection of the odometer icon 3808 causes the GUI 500 to display the odometer and automatically deactivates the speedometer. Accordingly, selection of the speed icon 3802 or the odometer icon 3808 alternatively selects the speedometer or odometer on the GUI 500 for display.

Referring particularly to FIG. 39, the third system GUI 3900 controls a brightness or dimness of the operator interface 48. The third system GUI 3900 includes a lightbulb icon 3902 and a slider 3904. The user may touch and slide the slider 3904 in either direction to increase or decrease the brightness of the operator interface 48.

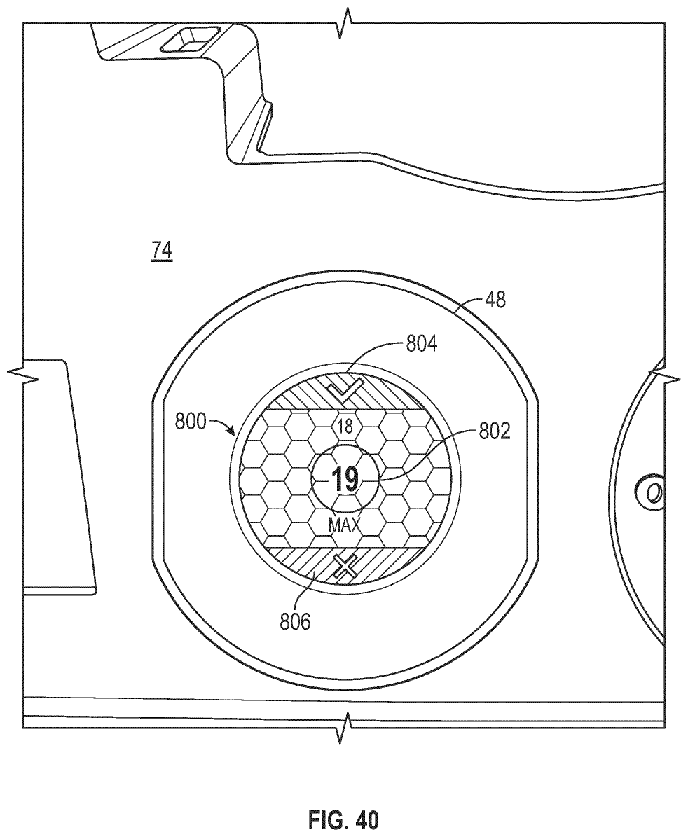

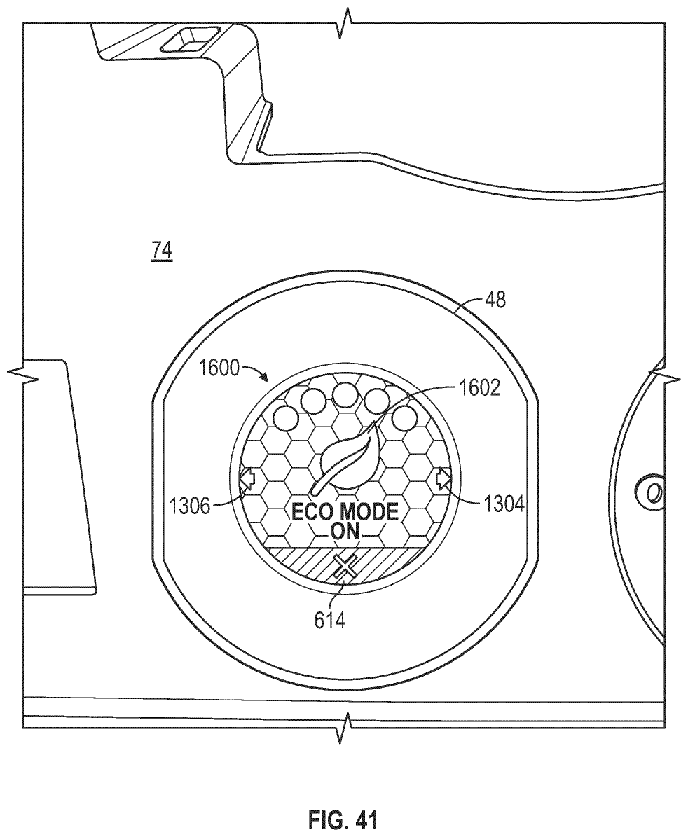

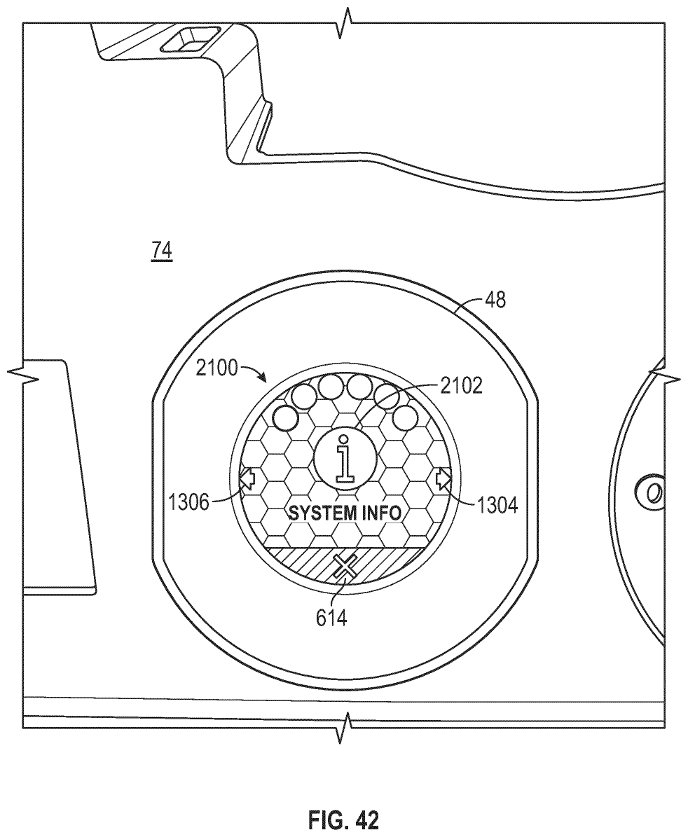

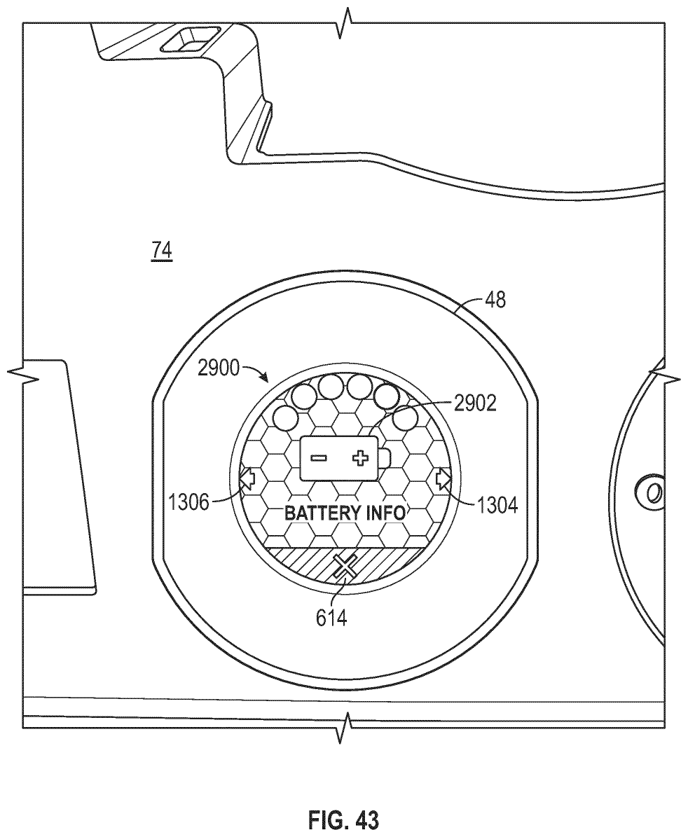

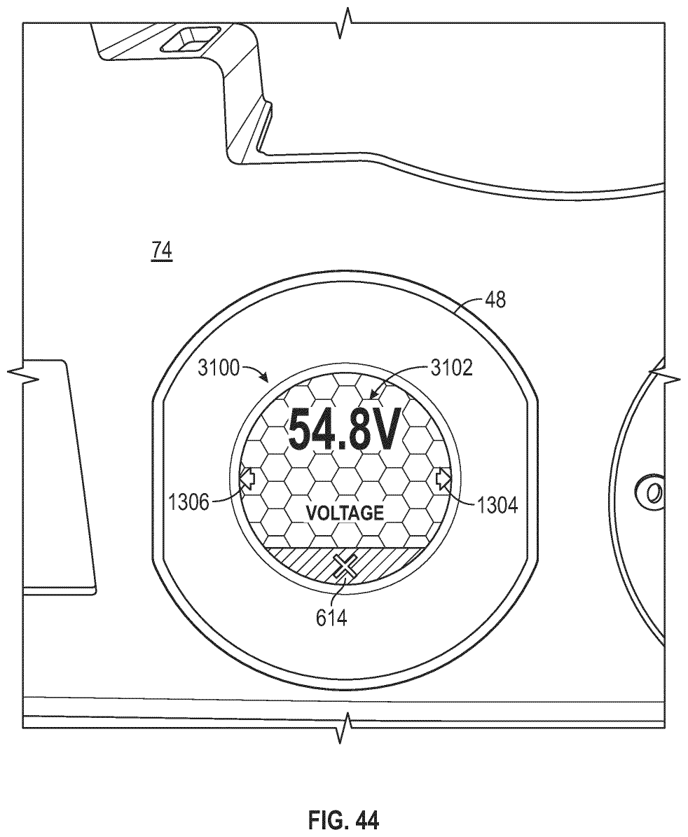

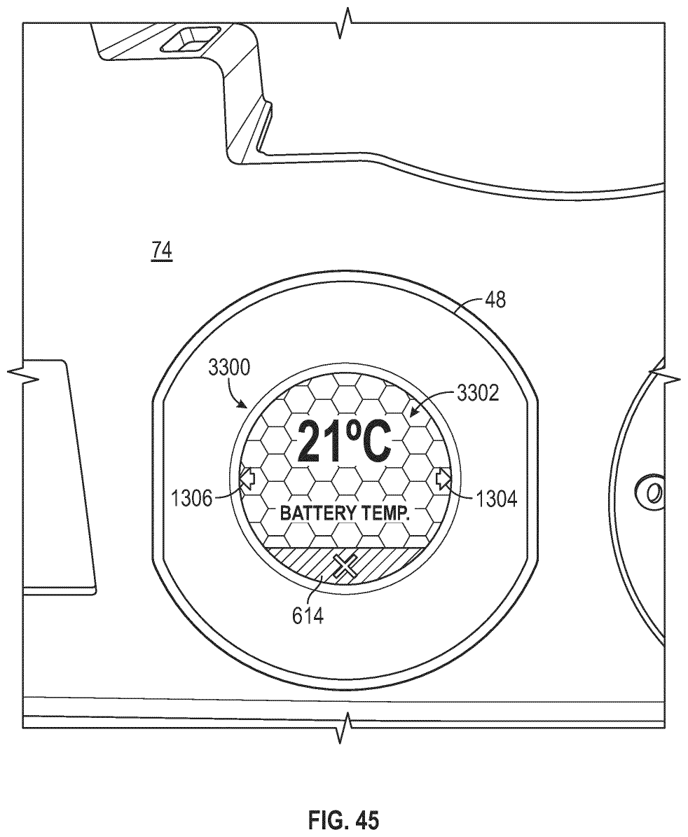

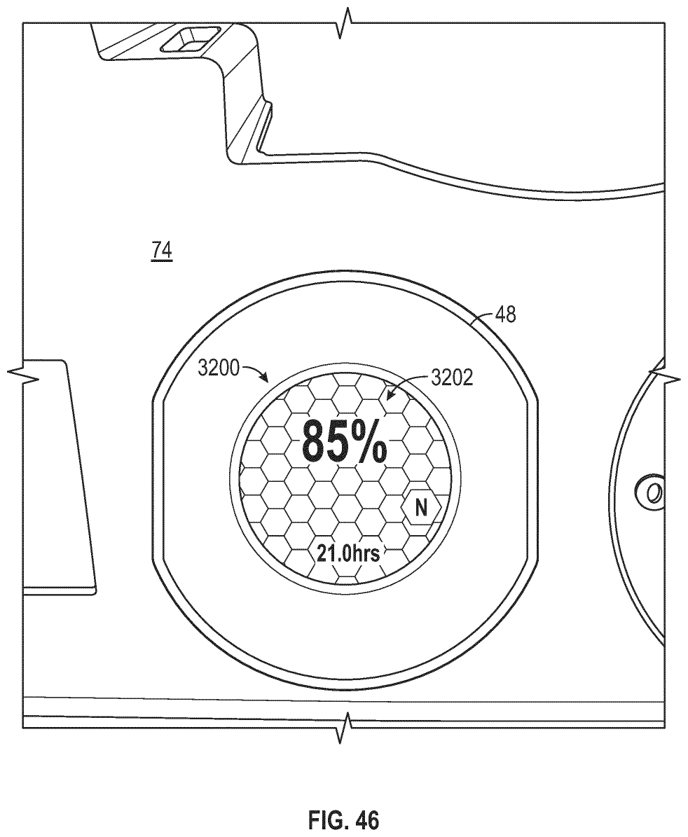

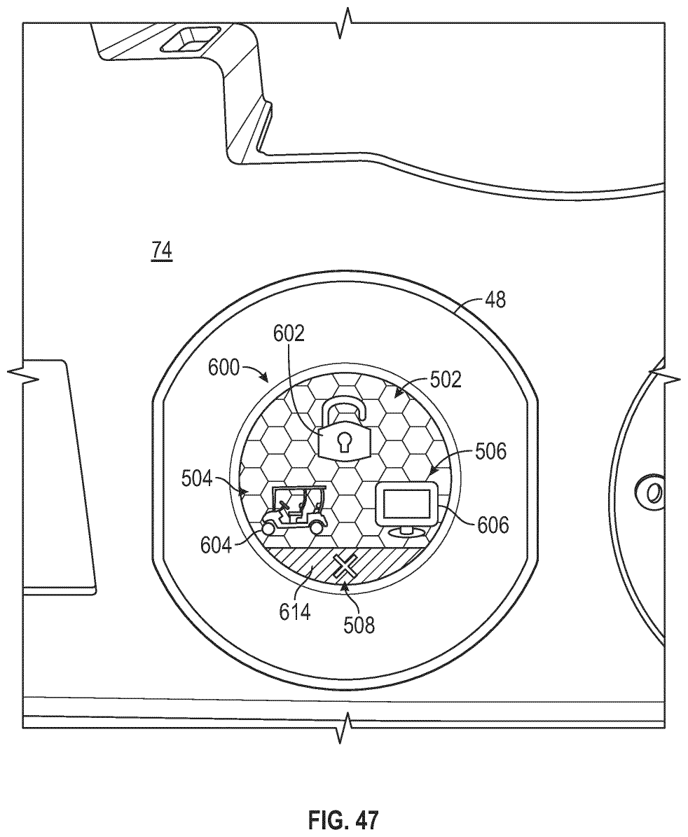

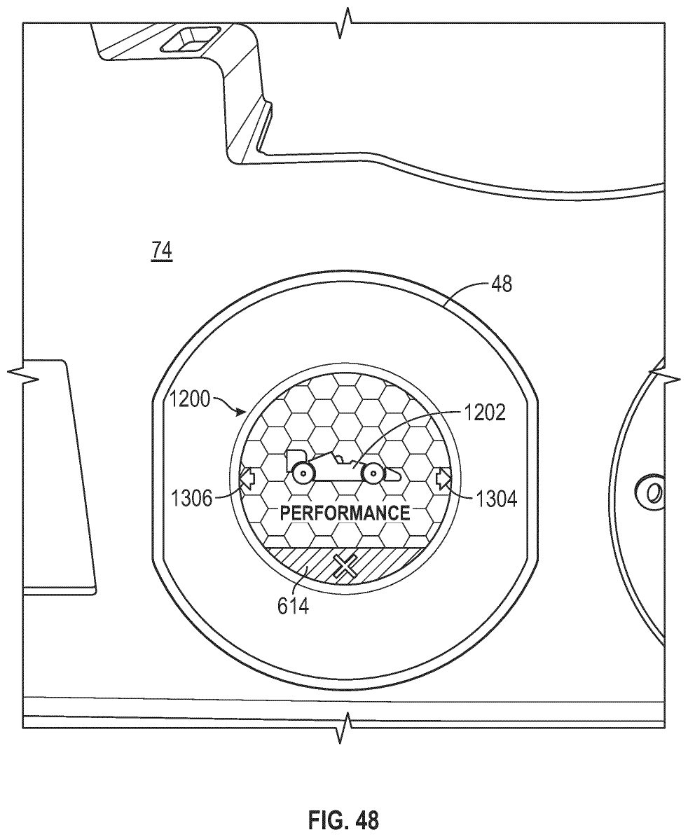

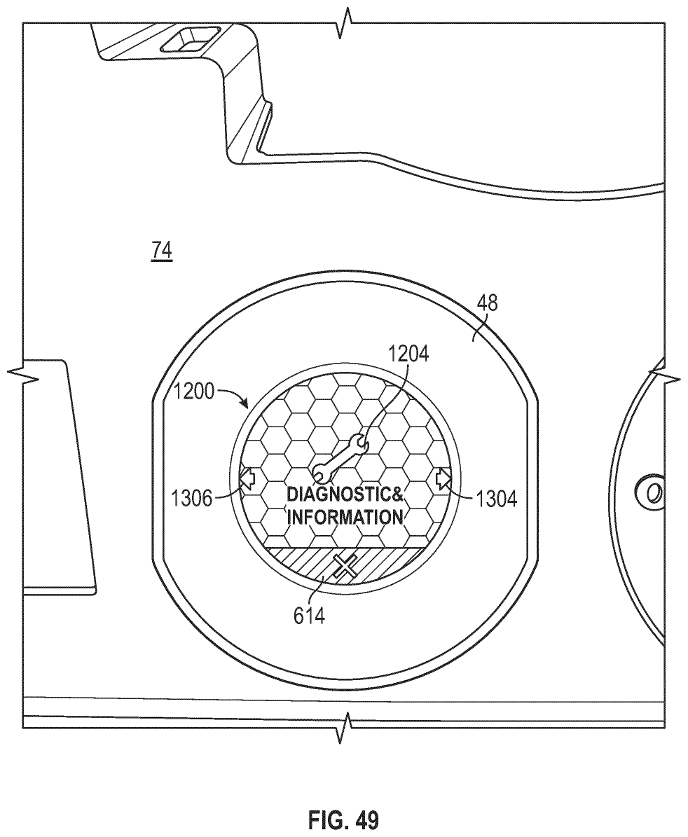

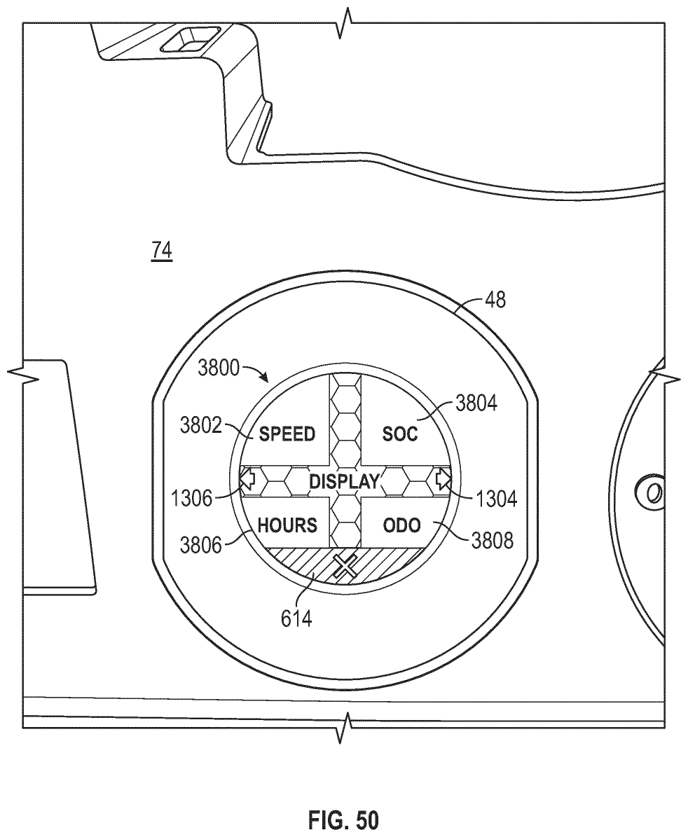

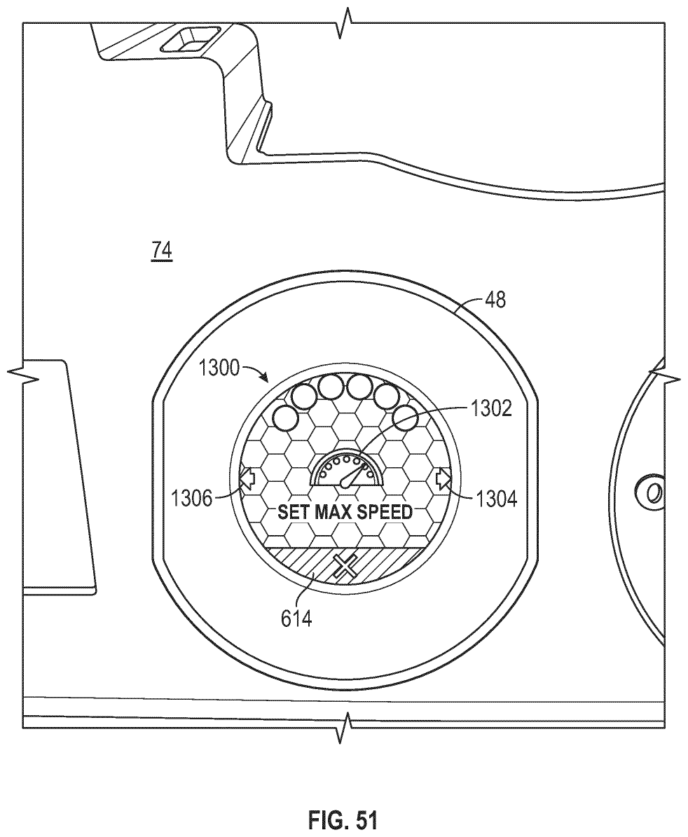

Referring to FIGS. 40-51, the operator interface 48 may be provided on a dashboard 74 of the vehicle 10. FIG. 40 illustrates the GUI 800 displayed on the operator interface 48. FIG. 41 illustrates the GUI 1600 displayed on the operator interface 48. FIG. 42 illustrates the GUI 2100 displayed on the operator interface 48. FIG. 43 illustrates the GUI 2900 displayed on the operator interface 48. FIG. 44 illustrates the voltage GUI 3100 displayed on the operator interface 48. FIG. 45 illustrates the battery temperature GUI 3300 displayed on the operator interface 48. FIG. 46 illustrates the battery health GUI 3200 displayed on the operator interface 48. FIG. 47 illustrates the second GUI 600 displayed on the operator interface 48. FIG. 48 illustrates an embodiment of the GUI 1200 displayed on the operator interface 48. FIG. 49 illustrates another embodiment of the GUI 1200 displayed on the operator interface 48. FIG. 50 illustrates the GUI 3800 displayed on the operator interface 48. FIG. 51 illustrates the GUI 1300 displayed on the operator interface 48.

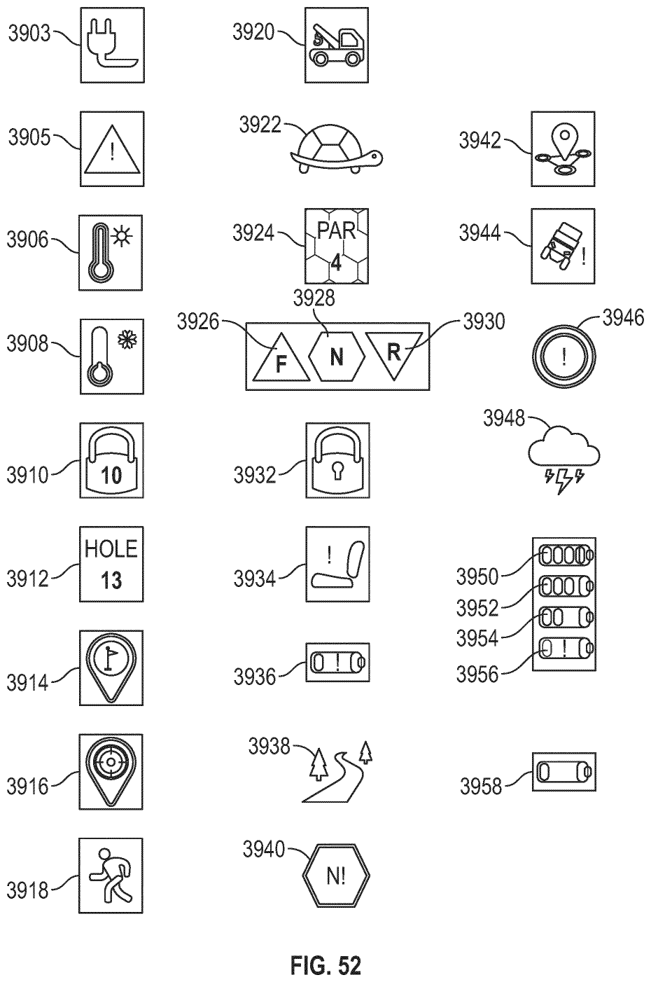

Referring to FIG. 52, various icons 3902-3958 may be presented on the first GUI 500 (e.g., a default GUI). The controller may control the operator interface 48 to provide any of the icons in any of the first area 502, the second area 504, the third area 506, or the fourth area 508. The icons include a charging connection icon 3903 indicating that the vehicle 10 is currently being charged. The icons also include a fault icon 3905 indicating that the vehicle 10 has experienced or is currently experiencing a fault. The icons also include a hot temperature cutback icon 3906 and a cold temperature cutback icon 3908 that can be provided to the user on the GUI 500. The icons also include a lock icon 3910 that indicates if a speed lock is active on the vehicle 10, and also provides a numerical value indicating what speed the vehicle 10 is limited to. The icons also include a hole number icon 3912 that indicates which hole the user is currently on (e.g., which hole of a golf course the vehicle 10 is currently within the boundaries of). The icons also include a distance to pin icon 3914 that indicates a total distance (e.g., yards) from a position that the vehicle 10 is currently at to a pin of the hole that the user is currently on. The icons also include a distance to center icon 3916 that indicates a total distance (e.g., yards) from the position that the vehicle 10 is currently at to a center of the hole that the user is currently on. The icons also include a walkaway icon 3918 indicating if walkaway has been detected or activated.

The icons also include a tow icon 3920 indicating whether the vehicle 10 is currently being towed or requires towing. The icons also include a slow play icon 3922 indicating if the user is implementing slow play. The icons also include a hole index icon 3924 that indicates a par of the current hole that the user is on. The icons also include a forward direction icon 3926, a neutral icon 3928, and a reverse direction icon 3930 indicating a current direction of travel or gear of the vehicle 10. The icons also include another lock icon 3932 that indicates if the vehicle 10 is in a locked mode (e.g., use of the vehicle 10 is restricted). The icons also include a seat switch icon 3934 indicating if a fault or activation of a seat switch has occurred. The icons also include a low battery icon 3936 indicating if the state of charge or level of the BMS 312 is low.

The icons also include a cart path only icon 3938 indicating that the vehicle 10 is currently on a path exclusively for golf carts or smaller vehicles. The icons also include a neutral drive icon 3940 that indicates that the vehicle 10 is currently in a neutral gear. The icons also include a restricted area icon 3942 that indicates if the vehicle 10 is currently in a restricted area. The icons also include an inertial measurement unit (“IMU”) derating icon 3944 that indicates if the vehicle 10 has a danger of tipping. The icons also include a speed zone icon 3946 that indicate if the vehicle 10 is currently traveling in a speed restricted area. The icons also include a weather warning icon 3948 that indicates if poor weather is predicted in the area of the vehicle 10. The icons also include a full battery icon 3950, a three-quarters battery icon 3952, a half battery icon 3954, a low battery icon 3958, and a charging needed battery icon 3956. The battery icons 3950-3958 indicate a state of charge of the BMS 312. The battery icons 3950-3958 include discrete sections that each correspond to 25% of the state of charge of the battery. In particular, the full battery icon 3950 includes four discrete sections, indicating that the BMS 312 is full (e.g., at 100%). The icons may also include a cruise control icon that, when selected, activates cruise control for the vehicle 10 until the icon is again selected, the brake 46 is operated, or the vehicle 10 is shut off.

Referring again to FIG. 5, the mode manager 420 may receive a selection from the user via the operator interface 48 to transition the controller 402 and therefore the operator interface 48 between different display modes. In particular, the mode manager 420 may transition the vehicle 10 between a display only mode, a standard mode, and a golf mode. In some embodiments, each of the different modes or settings can be enabled or disabled by the user. In some embodiments, the controller 402 implements different selections or settings (e.g., different modes) based on a model of the vehicle 10, the time of use, and/or who is operating the vehicle. For example, for fleet models, the controller 402 may implement the display only mode where settings cannot be adjusted, and one or more GUIs may not be accessible or viewable. For non-fleet models of the vehicle 10, the controller 402 may default to having the display only mode turned off and all GUIs viewable (though, some may require credentials for access). In this way, the controller 402 may select the display mode for the operator interface 48 based on the model of the vehicle 10 (e.g., a type of the vehicle 10). As another example, the mode that is activated may be based on the time of the day or day of the week. Accordingly, the display mode may be active during scheduled tee times and deactivated during a scheduled maintenance period. As another example, the display only mode may be activated when an owner pin is not entered (e.g., the vehicle 10 is being operated by someone other than the owner) and may be deactivated by the owner via their owner pin. In some embodiments, the display mode may be activated response to geographic location of the vehicle 10 (e.g., whether the vehicle 10 is within a geofence). For example, the display mode may be activated or deactivated responsive to the vehicle 10 being located on a golf course or on a hole of the golf course, or in a barn or storage area for the vehicle 10.

When the display only mode is activated, the user may be restricted from changing operating parameters of the vehicle 10 (e.g., the speed limit, the acceleration limit, the deceleration limit, etc., as described in greater detail above with reference to FIGS. 9-29) and/or limited to viewing only certain GUIs. The user may be allowed to deactivate the display only mode responsive to entering a pin or credential (e.g., via the GUIs described in greater detail above with reference to FIGS. 10-12, the owner pin, etc.) so that the user can set different control settings for the vehicle 10 that the controller 402 uses to adjust operation of the motor controller 310, the BMS 312, or more generally the vehicle 10. If the display only mode is deactivated, the user may be allowed to adjust operating parameters or control parameters of the vehicle 10.

When the golf mode is activated, the first GUI 500 is configured to display golf-related information obtained from the fleet management system 316. For example, referring to FIG. 6, the first area 502 may provide a numerical value of yards to a next pin on the golf course, and corresponding textual information “yards to pin.” The first area 502 may also display the numerical value in units of meters to the next pin and provide the corresponding textual information “meters to pin.” The second area 504 provides a number of a current hole that the user is on with the vehicle 10. The current hole and the numerical value of yards to the next pin may be determined by the controller 402 based on information obtained from the GPS 318 and map data of a golf course on which the vehicle 10 is allowed to travel. The third area 506 provides a hole index (e.g., a par for the hole). The fourth area 508 may be left blank until required to provide alerts or alarms to the user. For example, the fourth area 508 may provide custom messages, the weather warning icon 3948 (shown in FIG. 52), or the restricted area icon 3942 if the controller 402 detects that the vehicle 10 is being driven in a restricted area.

The third area 506 may be updated temporarily or periodically with the slow play icon 3922 responsive to detection that the user of the vehicle 10 is playing the hole slowly. In some embodiments, the second area 504 is updated temporarily or periodically to display the cart path icon 3938 or another warning icon if the controller 402 detects that the vehicle 10 has left a cart path. In some embodiments, the first area 502 is updated periodically, temporarily, or responsive to a user preference, to provide a distance (e.g., in yards, feet, or meters) to a center of the hole or a center of the golf course.

In some embodiments, the third area 506 provides a handicapped stroke index or a different stroke index based on the sex of the user. For example, if the user is female and provides a selection indicating a selection for female par data, the controller 402 may operate the operator interface 48 to provide the par for the hole for females in the third area 506. Likewise, if the user is male and provides a selection for male par data, the controller 402 may operate the operator interface to provide the par for the hole for males in the third area 506. The controller 402 may also operate the operator interface 48 such that the user can select a hole on which the user is currently playing or for which the user wishes to see corresponding data displayed on the first GUI 500 while in the golf mode. One or more of the first area 502, the second area 504, the third area 506, or the fourth area 508 may also provide the speed zone icon 3946 responsive to determining that the vehicle 10 has entered a speed restricted zone or is exceeding the speed limit for an area in which the vehicle 10 is currently traveling.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the user interfaces thereof (e.g., the first GUI 500, the second GUI 600, etc.) as shown in the various exemplary embodiments is illustrative only. Additionally, any element disclosed in one embodiment may be incorporated or utilized with any other embodiment disclosed herein.

1. A golf cart comprising:
a driveline;
a plurality of tractive elements configured to be driven by the driveline to transport the golf cart;
a user interface;
a communications bus; and
processing circuitry configured to:
acquire data regarding an operation of the golf cart from the communications bus;
operate the user interface based on the data regarding the operation of the golf cart;
acquire, via the user interface, an adjusted control setting for the golf cart; and
control, via communications on the communications bus, a system of the golf cart to adjust an operational characteristic of the golf cart based on the adjusted control setting.

2. The golf cart of claim 1, wherein the processing circuitry is configured to obtain, from the communications bus, data regarding an operation of the driveline or a driving operation of the golf cart, data regarding a fault of one or more systems of the golf cart, and data regarding a condition of an electrical system of the golf cart, wherein operating the user interface comprises operating the user interface to display the data regarding the operation of the driveline or the driving operation of the golf cart, the data regarding the fault, and the data regarding the condition of the electrical system via a plurality of graphical user interfaces.

3. The golf cart of claim 1, wherein the adjusted control setting comprises a limit value of an allowable speed of the golf cart, wherein controlling the system to adjust the operational characteristic comprises controlling the driveline of the golf cart to limit the golf cart from being driven at a speed that exceeds the limit value of the allowable speed.

4. The golf cart of claim 1, wherein the adjusted control setting comprises a limit value of an allowable acceleration of the golf cart, wherein controlling the system to adjust the operational characteristic comprises controlling the driveline of the golf cart to limit the golf cart from being driven at an acceleration that exceeds the limit value of the allowable acceleration.

5. The golf cart of claim 1, wherein the data regarding the operation of the golf cart comprises active or historical events and faults of systems of the golf cart that are communicably coupled with the communications bus, the processing circuitry configured to operate the user interface to alert a user regarding active events and faults of any of the systems, and operating the user interface to provide a list of historical events and faults of the systems.

6. The golf cart of claim 1, further comprising a battery configured to power the driveline, wherein the data regarding the operation of the golf cart comprises a voltage, current, health, and temperature of the battery.

7. The golf cart of claim 1, wherein the data regarding the operation of the golf cart comprises golf-specific information including at least one of a distance between a current location of the golf cart and a pin of a hole that the golf cart is currently on, a par of the hole that the golf cart is currently on, or a number of the hole that the golf cart is currently on, the processing circuitry configured to operate the user interface to display the golf-specific information.

8. The golf cart of claim 1, wherein the processing circuitry is configured to operate the user interface to provide a graphical user interface comprising a first area, a second area, a third area, and a fourth area, and wherein the first area is larger than the second area, the third area, and the fourth area.

9. The golf cart of claim 8, wherein information displayed in the first area, the second area, the third area, or the fourth area is customizable by a user by providing an input via the user interface.

10. The golf cart of claim 8, wherein information displayed in each of the first area, the second area, the third area, and the fourth area is selected by the processing circuitry based on a mode of operation that is activated by a user.

11. The golf cart of claim 8, wherein the first area, the second area, the third area, and the fourth area are configured to provide four of the following indications: a current speed of the golf cart, a distance between a current location of the golf cart and a pin of a current hole of the golf cart, a distance between the current location of the golf cart and a center of the current hole, a state of charge of a battery of the golf cart, an indication of whether the golf cart is currently being charged, whether the golf cart has experienced a fault, whether a temperature cutback has occurred, whether a speed of the golf cart is limited, whether operation of the golf cart is locked, whether the golf cart is currently on a cart path or not, a number of the current hole that the golf cart is on, an indication of whether a walkaway event has occurred in which a user has left the golf cart, whether the golf cart is currently involved in a tow scenario, whether a slow play condition is detected, a par for the current hole, a direction of travel of the golf cart, a gear or drive mode selection including forward, reverse, and neutral, an amount of time until the battery of the golf cart is fully charged, a seat switch status, a low battery warning, an indication whether the golf cart has entered a restricted area, a derating warning, a weather warning, an hour meter, or an odometer.

12. The golf cart of claim 1, wherein the processing circuitry is configured to selectively operate the user interface in a display only mode where the adjusted control setting cannot be entered by a user.

13. The golf cart of claim 12, wherein the processing circuitry is configured to control the user interface to display a plurality of graphical user interfaces, and wherein at least one of the plurality of graphical user interfaces in inaccessible by the user in the display only mode.

14. The golf cart of claim 12, wherein the processing circuitry is configured to disable the display only mode in response to acquiring credentials from the user that permit disabling the display only mode.

15. A display system for a golf cart, the display system comprising:
a touchscreen display; and
processing circuitry configured to:
acquire data regarding an operation of the golf cart from a communications bus of the golf cart;
operate the touchscreen display based on the data regarding the operation of the golf cart;
acquire, via the touchscreen display, an adjusted control setting for the golf cart; and
control, via communications on the communications bus, a system of the golf cart to adjust an operational characteristic of the golf cart based on the adjusted control setting.

16. The display system of claim 15, wherein:
the processing circuitry is configured to operate the touchscreen display to provide a graphical user interface comprising a first area, a second area, a third area, and a fourth area; and
the first area is larger than the second area, the third area, and the fourth area, and wherein information displayed in the first area, the second area, the third area, or the fourth area is customizable by a user by providing an input via the touchscreen display, or the information displayed in each of the first area, the second area, the third area, and the fourth area is selected by the processing circuitry based on a mode of operation that is activated by the user.

17. The display system of claim 15, wherein the processing circuitry is configured to:
selectively operate the touchscreen display in a display only mode where the adjusted control setting cannot be entered by a user;
control the user interface to display a plurality of graphical user interfaces, wherein at least one of the plurality of graphical user interfaces in inaccessible by the user in the display only mode; and
disable the display only mode in response to acquiring credentials from the user that permit disabling the display only mode.

18. The display system of claim 15, wherein the adjusted control setting comprises a limit value of an allowable speed of the golf cart, wherein controlling the system to adjust the operational characteristic comprises controlling a driveline of the golf cart to limit the golf cart from being driven at a speed that exceeds the limit value of the allowable speed.

19. The display system of claim 15, wherein the data regarding the operation of the golf cart comprises golf-specific information including at least one of a distance between a current location of the golf cart and a pin of a hole that the golf cart is currently on, a par of the hole that the golf cart is currently on, or a number of the hole that the golf cart is currently on, the processing circuitry configured to operate the touchscreen display to display the golf-specific information.

20. A vehicle comprising:
a dashboard;
a touch screen display disposed on the dashboard, the touch screen display configured to both display information and acquire user inputs; and
processing circuitry configured to:
acquire fault data from a communications bus of the vehicle;
operate the touch screen display to notify a user regarding fault data of the vehicle, the fault data associated with any of a plurality of systems communicably coupled with the communications bus;
acquire a user input to adjust an operation of a driveline operation of the vehicle; and
adjust operation of a driveline of the vehicle based on the user input.
